(19) United States
(12) Patent Application Publication
(10) Pub. No.: US 2016/0027082 A1
(43) Pub. Date: Jan. 28, 2016

(54) VIRTUAL SHOP FOR ELECTRONIC GREETING CARDS

(71) Applicant: AMERICAN GREETINGS CORPORATION, Cleveland, OH (US)

(72) Inventors: David Noyes, Berea, OH (US); Katie Drenik, Avon, OH (US); Robert Matousek, Lakewood, OH (US)

(21) Appl. No.: 14/774,999

(22) PCT Filed: Mar. 12, 2014
(86) PCT No.: PCT/US14/24074

§ 371 Date: Sep. 11, 2015

Related U.S. Application Data
(60) Provisional application No. 61/778,408, filed on Mar. 12, 2013.

(51) Int. Cl. G06Q 30/06; G06Q 50/00

(52) U.S. Cl. CPC G06Q 30/0621; G06Q 50/01

(57) ABSTRACT

A mobile optimized browser builder for creating, editing, distributing, and viewing an electronic greeting card on a portable computing device after a code is scanned by the portable computing device.

### PRIORITY CLAIM

This application claims the benefit of and priority to U.S. Provisional Patent Application No. 61/778,408 filed on Mar. 12, 2013, entitled “VIRTUAL SHOP FOR ELECTRONIC GREETING CARDS,” which is incorporated by reference in full in this application.

### FIELD OF THE INVENTION

The general inventive concepts relate to electronic greeting cards and, more particularly, to systems, methods, and apparatuses for creating, editing, distributing, and viewing electronic greeting cards on a portable computing device.

### BACKGROUND

Paper greeting cards have been widely used for a number of decades. The benefits and uses of paper greeting cards have been well documented in the art. With the advent of technology, paper greeting cards have been steadily replaced with electronic greeting cards, which satisfy the many benefits and uses of paper greeting cards.

Electronic greeting cards have been largely limited to desktop platforms owing to the resource-intensive nature of such cards. Lately, electronic greeting cards have been implemented as part of mobile applications in portable computing devices.

However, portable computing devices utilize several different operating systems, i.e. software and hardware frameworks. Therefore, electronic greeting cards have been limited to being implemented on frameworks specific to the devices which render them.

There is a need to provide for systems, methods, and apparatuses which allow a user to create, edit, view, and distribute electronic greeting cards on portable computing devices without depending on the specific framework of the devices which render them.

### BRIEF SUMMARY

The general inventive concepts contemplate systems, methods, and apparatuses for creating, editing, distributing, and viewing electronic greeting cards on a portable computing device. By way of example, to illustrate various aspects of the general inventive concepts, several exemplary embodiments of systems, methods, and/or apparatuses are disclosed herein.

An inventive mobile optimized browser builder for creating, editing, distributing, and viewing a specific electronic greeting card on a portable computing device after a code is scanned by the portable computing device is described. The rendering of the card on the mobile device is optimized for that particular type of mobile device.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the appended claims. It is to be understood that both the foregoing brief summary and the following detailed description are exemplary and explanatory only and are not restrictive of the embodiments disclosed herein or as claimed.

### BRIEF DESCRIPTION OF THE DRAWINGS

The accompanying drawings, which are incorporated in and constitute a part of this specification, illustrate some embodiments disclosed herein, and together with the description, serve to explain principles of the embodiments disclosed herein.

FIG. 1 represents a high-level flow chart that describes the generation and communication of a customizable electronic greeting card of the inventive system.

FIGS. 2-9 show exemplary marketing collateral in accordance with an embodiment of the present invention.

FIGS. 10-12 describe a high-level overview of an ecard app for creating, editing, distributing, and viewing electronic greeting cards on a portable computing device.

FIGS. 13-16 describe a high-level overview of a mobile optimized browser builder for creating, editing, distributing, and viewing electronic greeting cards on a portable computing device.

FIGS. 17-37 describe the operations of a mobile optimized browser builder for creating, editing, distributing, and viewing electronic greeting cards on a portable computing device.

### DETAILED DESCRIPTION

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise.

The following are definitions of exemplary terms used throughout the disclosure. Both singular and plural forms of all terms fall within each meaning:

“Computer” or “computing device” or “processing unit” as used herein includes, but is not limited to, any programmed or programmable electronic device, microprocessor, or logic circuit that can store, retrieve, and process data.

“Portable computing devices” include, but are not limited to, computing devices that combine the powers of a conventional computer in portable environments. Exemplary portable computing devices include portable computers, tablet computers, interne tablets, Personal Digital Assistants (PDAs), ultra mobile PCs (UMPCs), carputers (typically installed in automobiles), wearable computers, and smartphones. The term “portable computing device” can be used synonymously with the terms “computer” or “computing device” or “processing unit.”

“Web browser” as used herein, includes, but is not limited to, software for retrieving and presenting information resources on the World Wide Web. An information resource may be a web page, an image, a video, a sound, or any other type of electronic content.

“Software” or “computer program” as used herein includes, but is not limited to, one or more computer or machine readable and/or executable instructions that cause a computer, a portable computing device, microprocessor, logic circuit, or other electronic device to perform functions, actions, and/or behave in a desired manner. The instructions may be embodied in various forms such as routines, algorithms, modules or programs, including separate applications or code from dynamically linked libraries. Software may also be implemented in various forms such as a stand-alone program, an app, a mobile application, a function call, a servlet, an applet, instructions stored in a memory or any other computer readable medium, part of an operating system or other type of executable instructions. It will be appreciated by one of ordinary skill in the art that the form of software is dependent on, for example, requirements of a desired application, the environment it runs on, and/or the desires of a designer/programmer or the like.

“Mobile application” as used herein, includes, but is not limited to, applications that run on smart phones, tablet computers, and other mobile or portable computing devices. The terms “mobile application” or “mobile app” or “software application” or “application” or “app” can be used synonymously with “software” or “computer program” or “application software.” Mobile applications allow users to connect to services that are traditionally available on the desktop or notebook platforms. Typically, these services access the Internet or intranet or cellular or wireless fidelity (Wi-Fi) networks, to access, retrieve, transmit and share data.

“Memory” as used herein is memory that is visible to and/or directly addressable by software executed on a processor.

“Processor” as used herein, refers to central processing units, microprocessors, microcontrollers, reduced instruction set circuits (RISC), application specific integrated circuits (ASIC), logic circuits, and any other circuit or processor capable of executing the functions described herein.

“Network” as used herein, includes, but is not limited to, a collection of hardware components and computers or machines interconnected by communication channels that allow sharing of resources and information, including without limitation, the worldwide web or Internet. A network maybe “wireless,” “wired,” or a combination of wired and wireless networks.

“Server” as used herein, includes, but is not limited to, a computer or a machine or a device on a network that manages network resources. The general term “server” may include specific types of servers, such as a Web Server, File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

“Web server” as used herein, includes, but is not limited to, a server which serves content to a web browser by loading a file from a disk, or automatically generating a response by combing a search result from a database or other repository with calculations based on client request parameters and business rules and logic embedded in the software, and serving it across a network to a user's web browser, typically using a hyper text transfer protocol (HTTP).

“Instructions” as used herein is synonymous to “Source code” or “product code”, and includes, but not limited to, a textual software code, or a machine code, or notations in graphical software languages, which specify actions to be performed by a machine, which includes, but not limited to, a computer.

“SVG” or “SVG File” or “Scalable Vector Graphics” or “Scalable Vector Graphics File” as used herein, includes, but not limited to, a vector graphics file format which enables the display of certain multi-dimensional images in XML pages on the web.

“XML” or “Extensible Markup Language” as used herein, includes, but not limited to, a set of rules for encoding documents in a machine-readable form.

“Call” or “System Call” or “Pull” or “Pulled” as used herein, includes, but not limited to, a mechanism by which a program makes a request for a service from either an operating system or an application program or software.

“API Files” or “API” or “Application Programming Interface” as used herein, includes, but not limited to, an interface between different software programs or software files, which facilitates the interaction of the different software programs or software files by way of a specific set of rules and specifications.

“XINCLUDE” as used herein, includes, but not limited to, a mechanism whereby multiple XML documents are merged. The merger is accomplished by incorporating inclusion tags in the source XML document which prompts the source XML document to include other documents or parts of other XML documents resulting in a single XML Information Set.

“Source code” or “product code” as used herein, includes, but not limited to, a textual software code, a programming language code, or a machine code, or notations in graphical software languages, which specify actions to be performed by a machine, which includes, but not limited to, a computer.

All publications and patent applications mentioned herein are incorporated herein by reference to disclose and describe the materials, methods and/or systems in connection with which the publications or applications are cited. It is understood that the present disclosure supersedes any disclosure of an incorporated publication to the extent there is a contradiction.

### HIGH LEVEL LOGIC FLOW OF THE SYSTEM

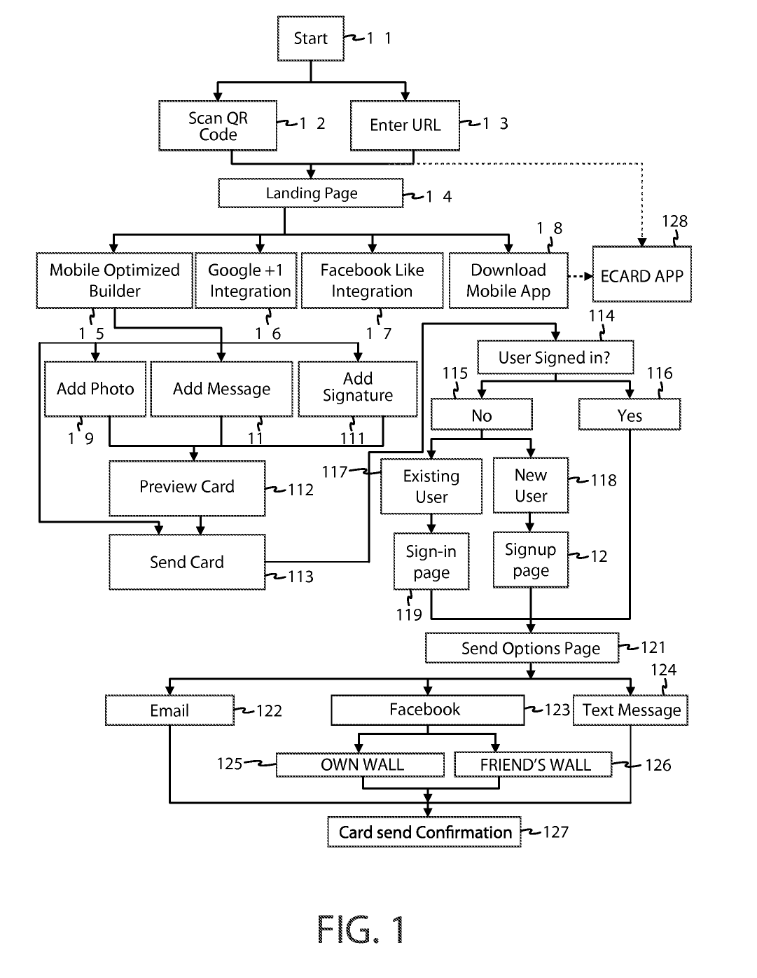

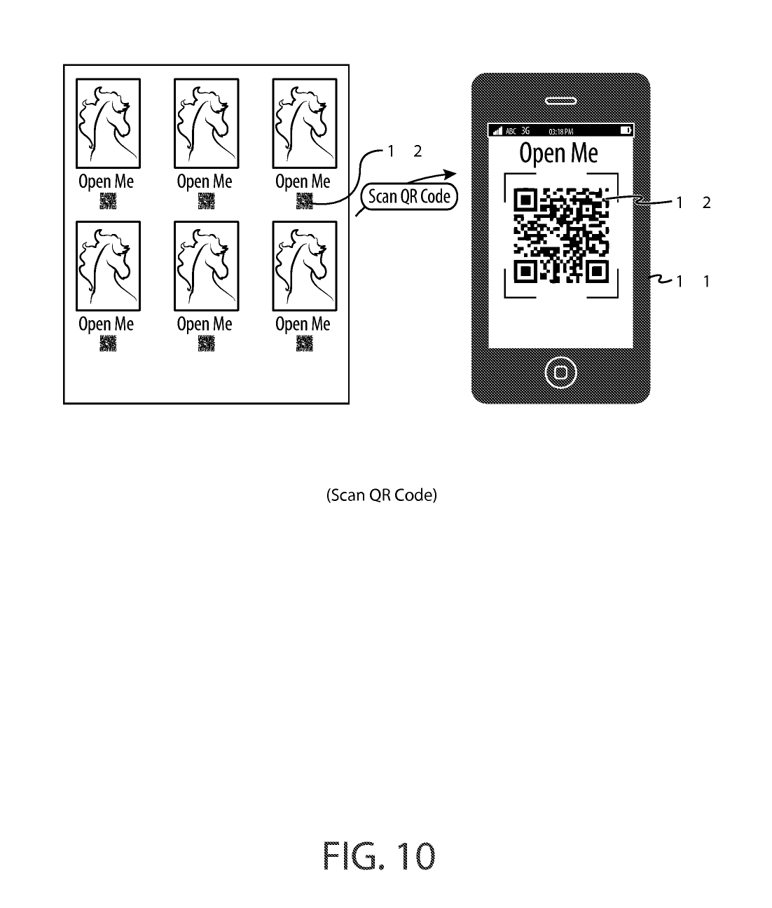

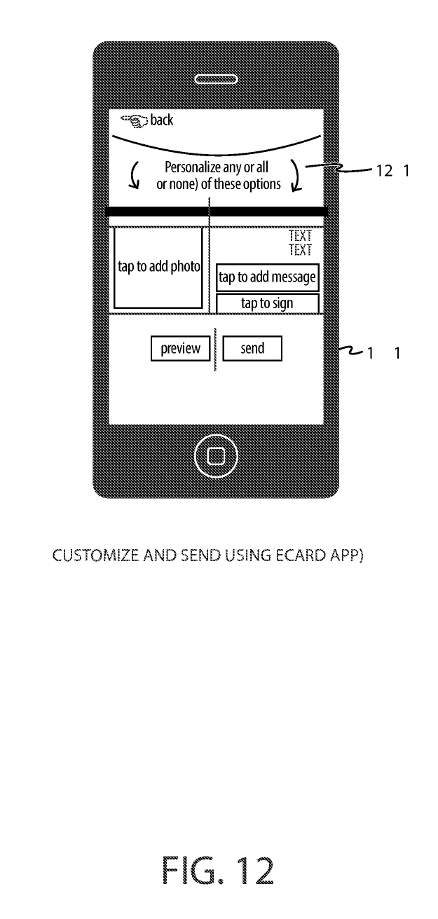

Reference will now be made to the drawings. FIG. 1 is a flow chart of system 100 of the present invention. At 101, an electronic greeting card user (“sender 150”) is presented with two options: Scanning a QR Code 1002 (see FIG. 10) at step 102, or Entering a URL 1005 (see FIG. 10) at step 103, using a portable computing device 1001 (shown in FIG. 10). Once sender 150 either scans the QR code 1002 at 102 or enters the URL 1005 at 103, if sender's portable computing device 1001 was previously installed with an ecard app 1201 (as shown in FIG. 12) (described further below), sender 150 is directed to the ecard app 1201 at step 128. Otherwise, sender 150 is directed to a landing page at 104 where sender 150 is able to view a home screen for a particular electronic greeting card 130 (not shown) linked to the QR Code 1002 or the URL 1005 entered at steps 102 or 103 respectively. Effectively scanning the QR Code results in the portable computing device translating the QR Code into the URL 103 and then resolving the URL 103 for landing page 104.

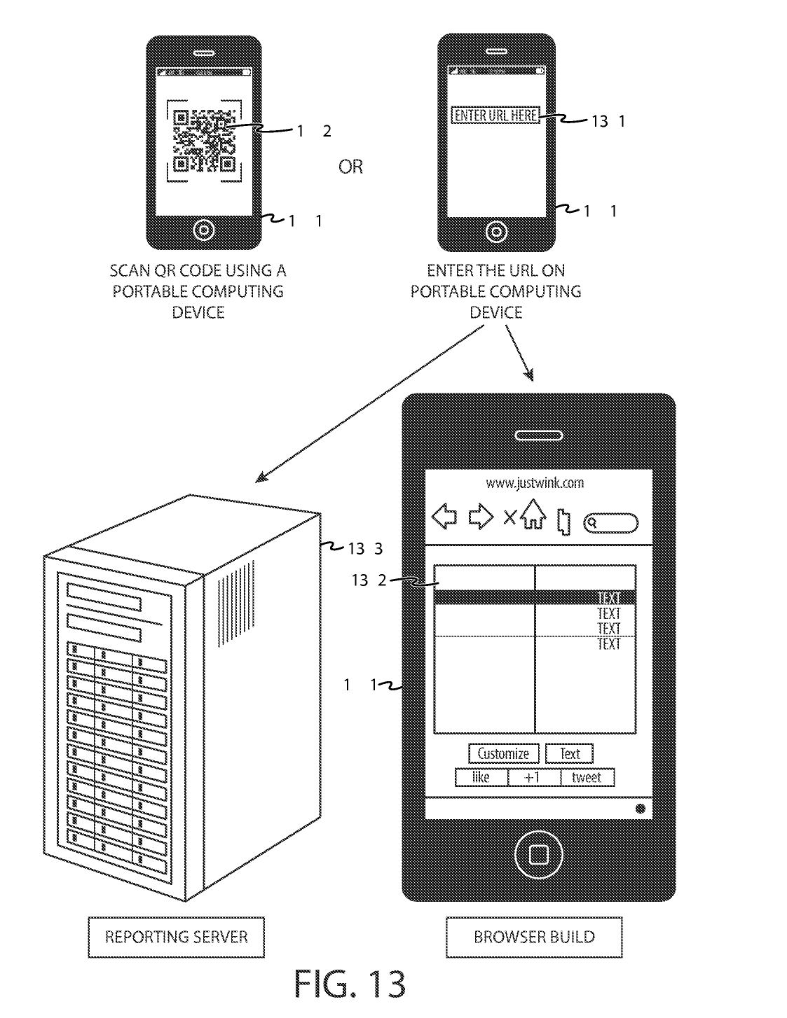

At step 104, sender 150 is presented with four options on the landing page, described in steps 105-108. At step 105, sender 150 may enter a mobile optimized browser builder 1302 (See FIG. 13). At step 106, sender 150 may recommend the electronic greeting card 130 via Google+®. At step 107, sender 150 may “like” the electronic greeting card 130 on Facebook®. At step 108, sender 150 may download a mobile application capable of the features of the mobile optimized browser builder 1302 previously disclosed at step 105. Sender 150 may be able to select all four of these options in steps 105-108 in any order, as none of the four options are mutually exclusive.

If sender 150 chooses to recommend the electronic greeting card 130 at step 106, sender 150 is prompted with a login screen where sender 150 is able to enter their user credentials (e.g. a username and a password) associated with system 100 or with a third-party system such as Google®. Once logged in, sender 150 is able to recommend the electronic greeting card 130 to sender's contacts on Google+. If sender 150 chooses to “like” the electronic greeting card 130 at step 107, sender 150 is prompted with a login screen where sender 150 is able to enter their user credentials (e.g. a username and a password) associated with system 100 or with a third-party system such as Facebook®. Once logged in, sender 150 is able to “like” the electronic greeting card 130. At both steps 106 and 107, if sender 150 has previously logged in to system 100 either via the Google+® or Facebook® services, sender 150 may be able to bypass the login step and proceed directly to the recommend or like steps respectively.

If sender 150 elects to download a mobile app at step 108, sender 150 is prompted to download an ecard app 1201. The ecard app 1201 may be available via any known mobile app download medium, including, but not limited to, Google Play® or Google Store® (for Android® devices), App Store® (for iOS® devices), and Windows Store® (for Windows® devices). The ecard app 1201 will embody all functionality and features described herein with reference to the mobile optimized browser builder 1302 at step 105 (discussed in further detail below). However, the ecard app 1201 will be implemented as a mobile application, while the mobile optimized browser builder 1302 will be implemented on a web browser of the portable computing device 1001. Once the ecard app 1201 is downloaded and installed on device 1001, sender's interactions with the app 1201 will continue at step 128. Exemplary embodiments describing sender's interactions in downloading and installing the ecard app 1201, and the operations and flow of building and distributing an electronic greeting card via the ecard app 1201 are fully described in U.S. patent application Ser. No. 13/460,045, entitled “SYSTEMS, METHODS AND APPARATUSES FOR CREATING, EDITING, DISTRIBUTING, AND VIEWING ELECTRONIC GREETING CARDS,” which is hereby incorporated by reference in full (“the '045 application”).

If sender 150 elects to build an electronic greeting card 130 at step 105, sender 150 is directed to three personalization steps 109, 110, and 111 of the mobile optimized browser builder 1302, which allow sender 150 to personalize the electronic greeting card 130 by adding a photo, adding a message, and adding a signature respectively. The personalization steps 109, 110, and 111 are described in more detail in the '045 application. Sender 150 can then preview the customized card 130 at step 112, and choose to send the card 130 at step 113.

If sender 150 chooses to send the card 130 at step 113, system 100 checks to see if sender 150 is signed in to services offered as part of system 100 at step 114. At step 116, if sender 150 is signed in, sender 150 is directed to the send options page at step 121. If sender 150 is not singed in, sender 150 is presented with two (2) choices: an existing user sign in page at step 117, or a new user sign up page at step 118. If sender 150 is an existing user of system 100, sender 150 is directed to step 119, where sender 150 signs in to system 100 using their user credentials (e.g. a username and a password). After the sign-in, sender 150 is directed to the send options page at step 121. If sender 150 is a new user to system 100, sender 150 is directed to step 120, where sender 150 creates new user credentials (e.g. a username and a password). After the new user creation, sender 150 is directed to the send options page at step 121.

At step 121, sender 150 is able to choose between three (3) send options: the option to send the electronic greeting card 130 as an email (step 122), via Facebook® (step 123), or as a text message (step 124). If sender 150 chooses the Facebook® step at 123, sender 150 is able to either select and send the electronic greeting card 130 to a contact on Facebook®, or simply share the electronic greeting card on their own Facebook “wall.” Regardless of the option chosen (122, 123, or 124), sender 150 is then directed to a card send confirmation page at step 127, thereby completing the send cycle.

### MARKETING COLLATERAL

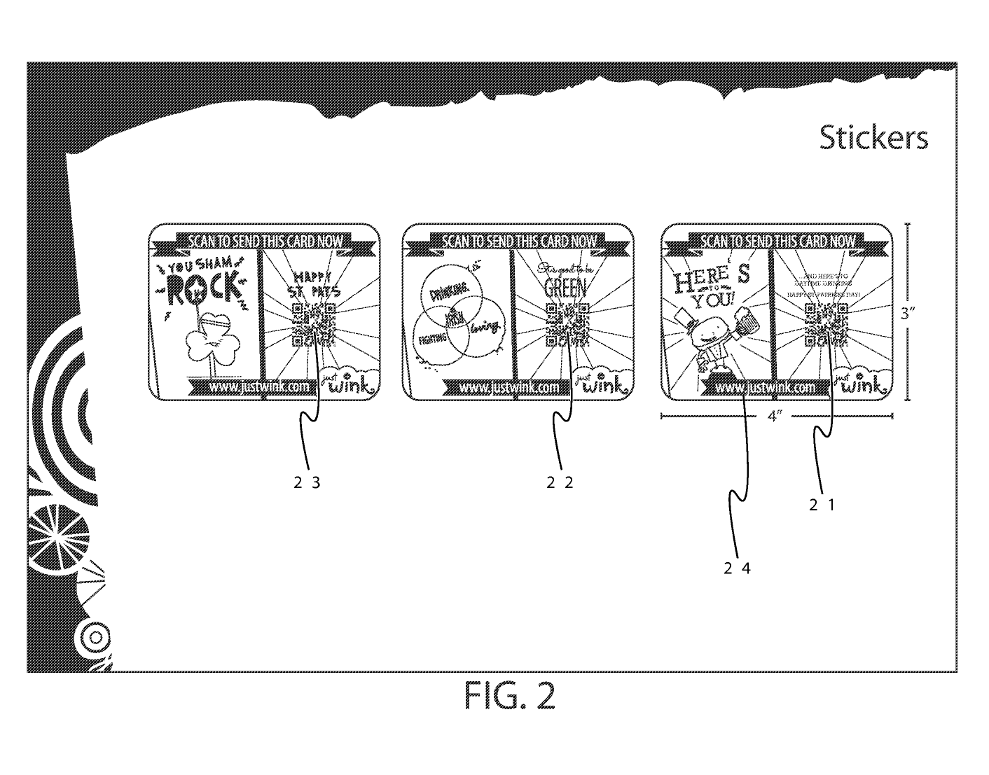

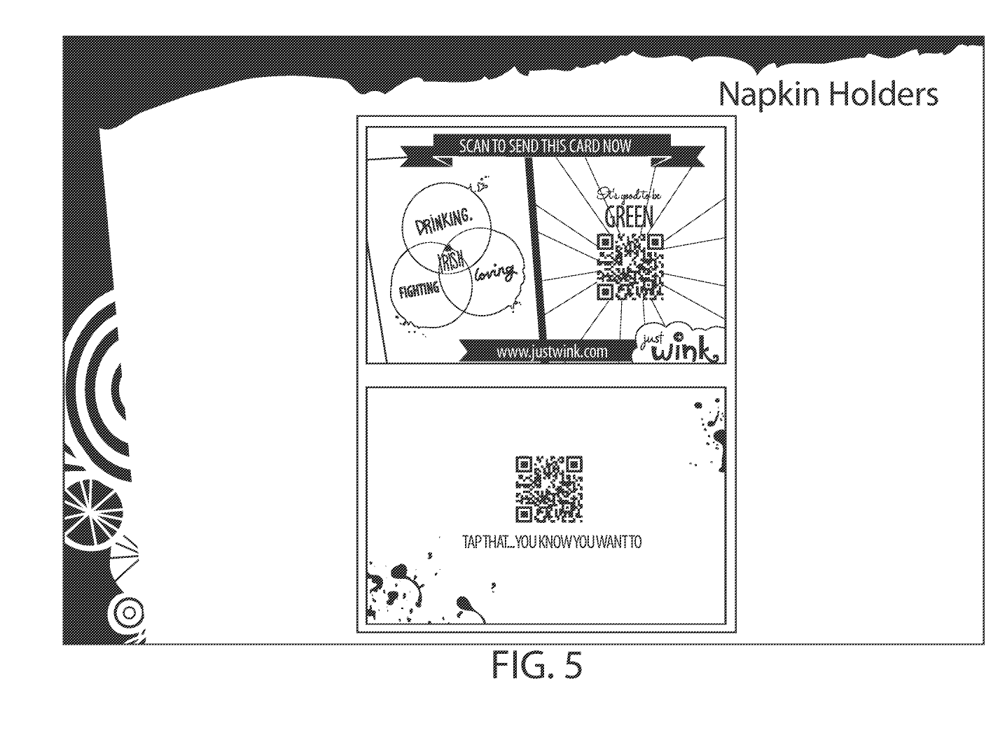

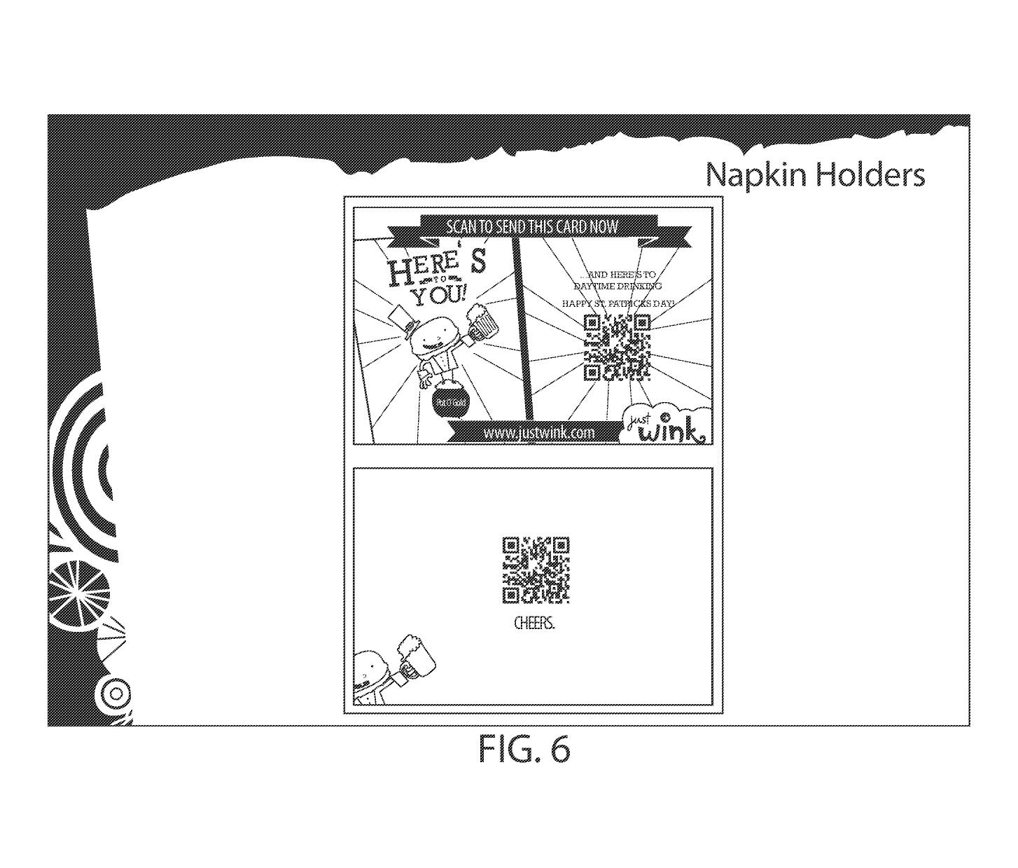

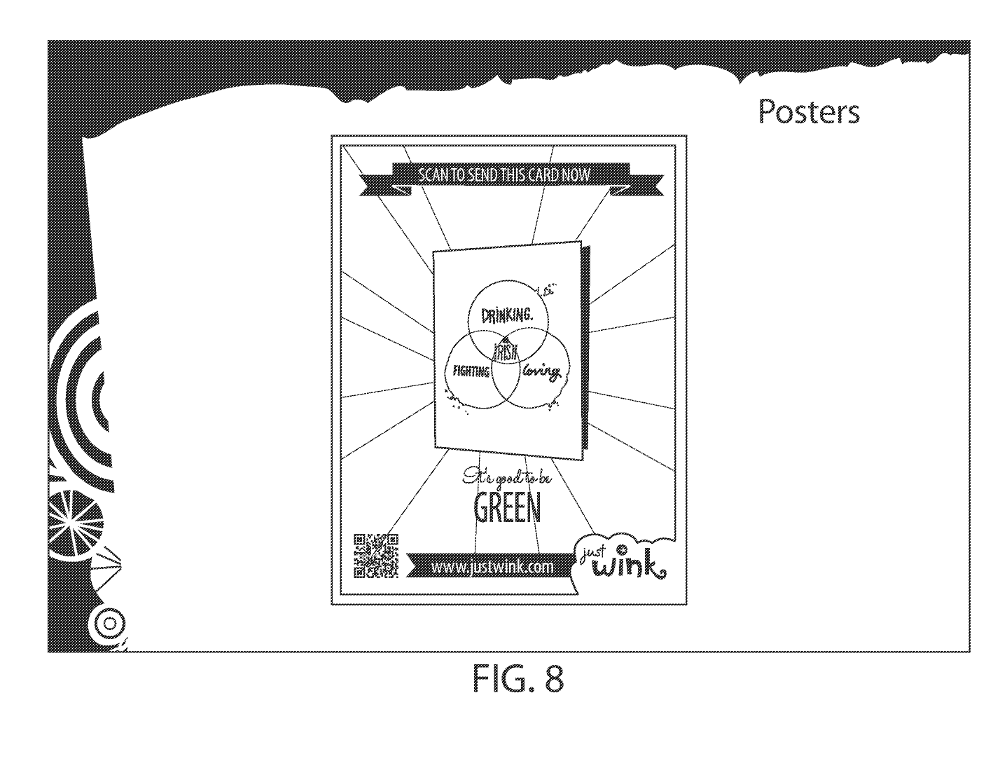

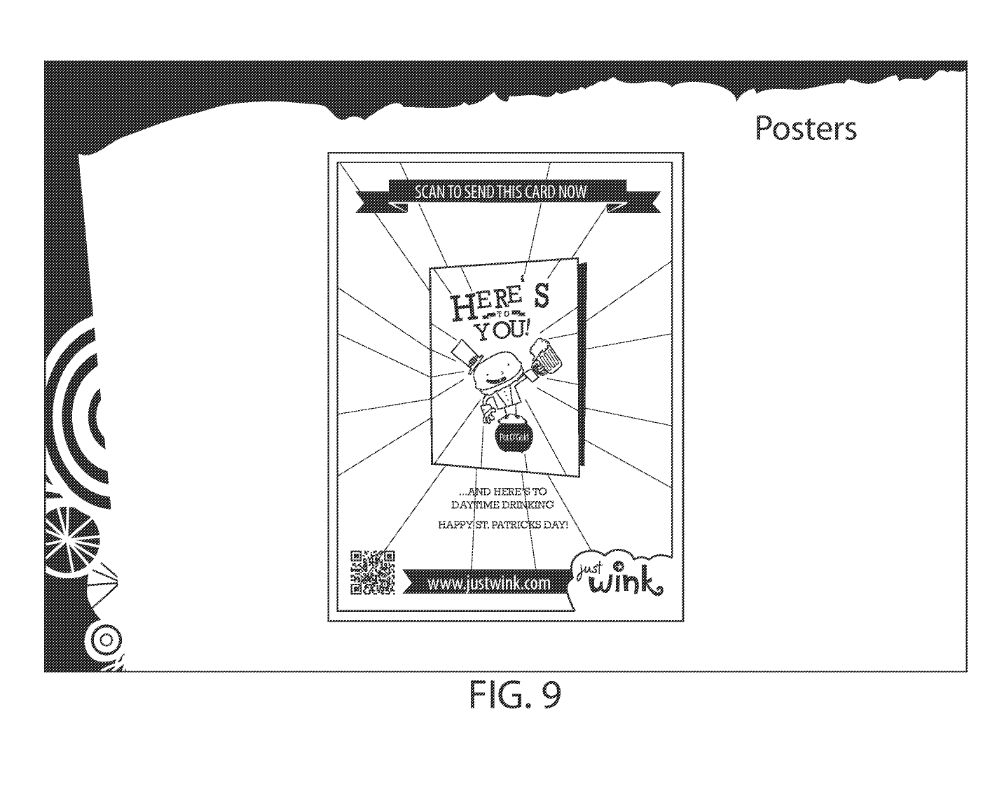

Sender 150 typically first interacts with the system 100 by scanning the QR Code 1002 with their portable computing device 1001. Although the embodiments described herein are illustrated with reference to the QR Code 1002, any other type of scannable code such as a bar code may be used in the present invention without departing from the spirit of the invention. Accordingly, it is expressly intended that all such equivalents, variations and changes which fall within the spirit and scope of the present invention as defined in the claims be embraced thereby. Alternately, sender 150 may also directly enter a URL (e.g., an easy to remember “vanity” URL) on the web browser of their portable computing device 1001. The QR Code 1002 or the URL 1005 may be placed on marketing collateral which may then be distributed both in print and electronic medium. Exemplary marketing collateral is displayed in FIGS. 2-9.

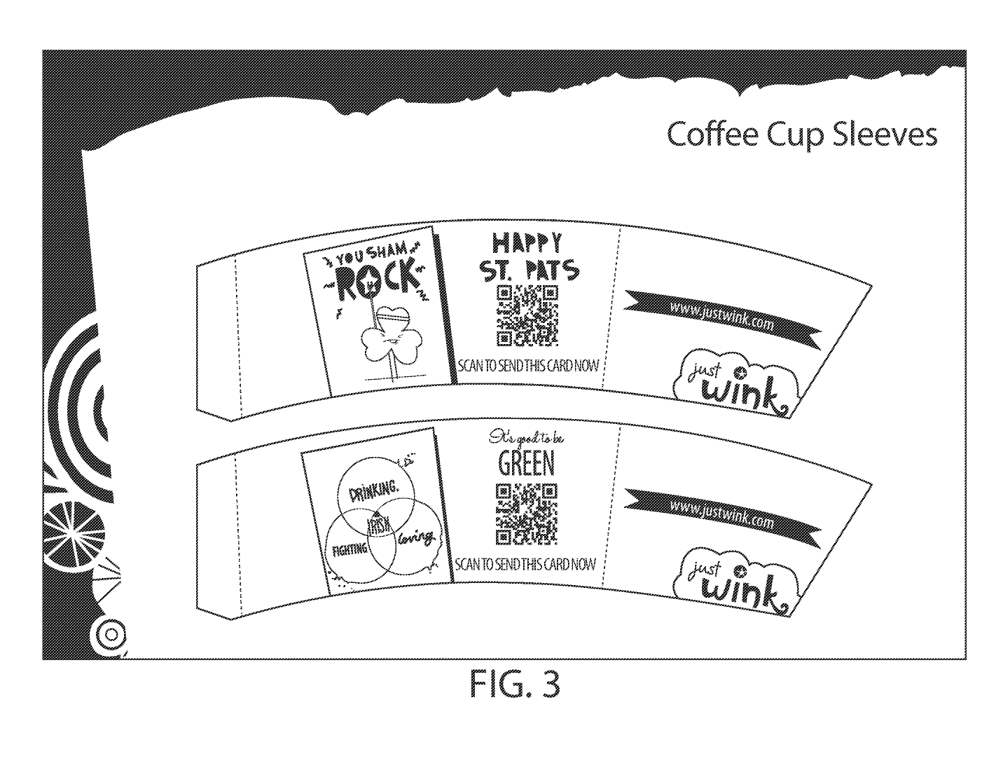

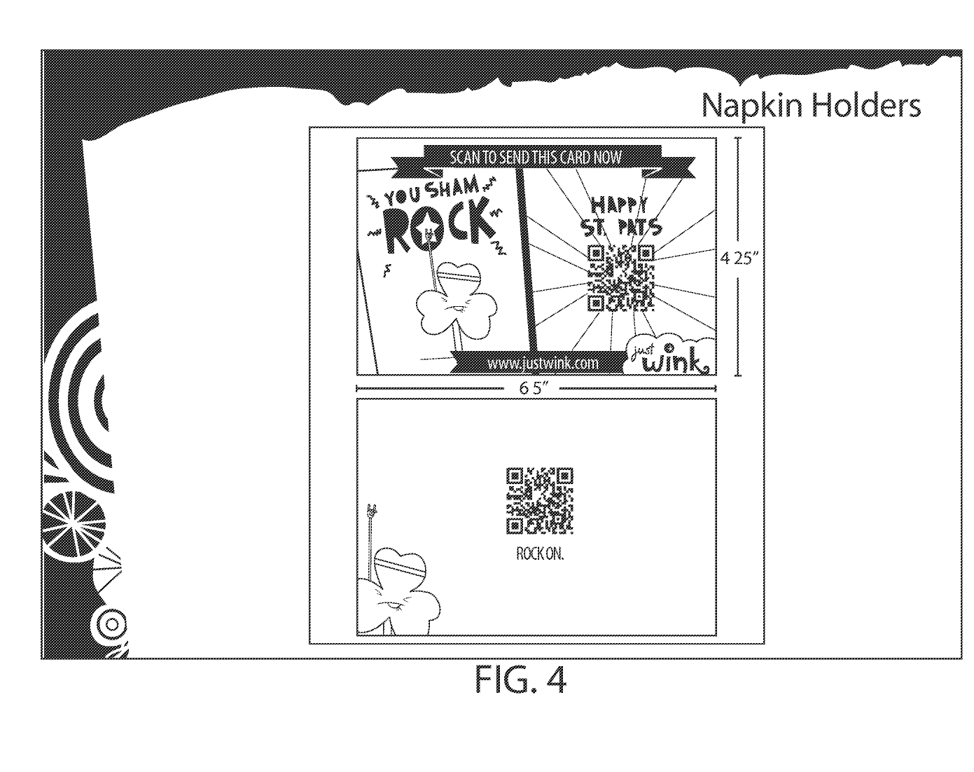

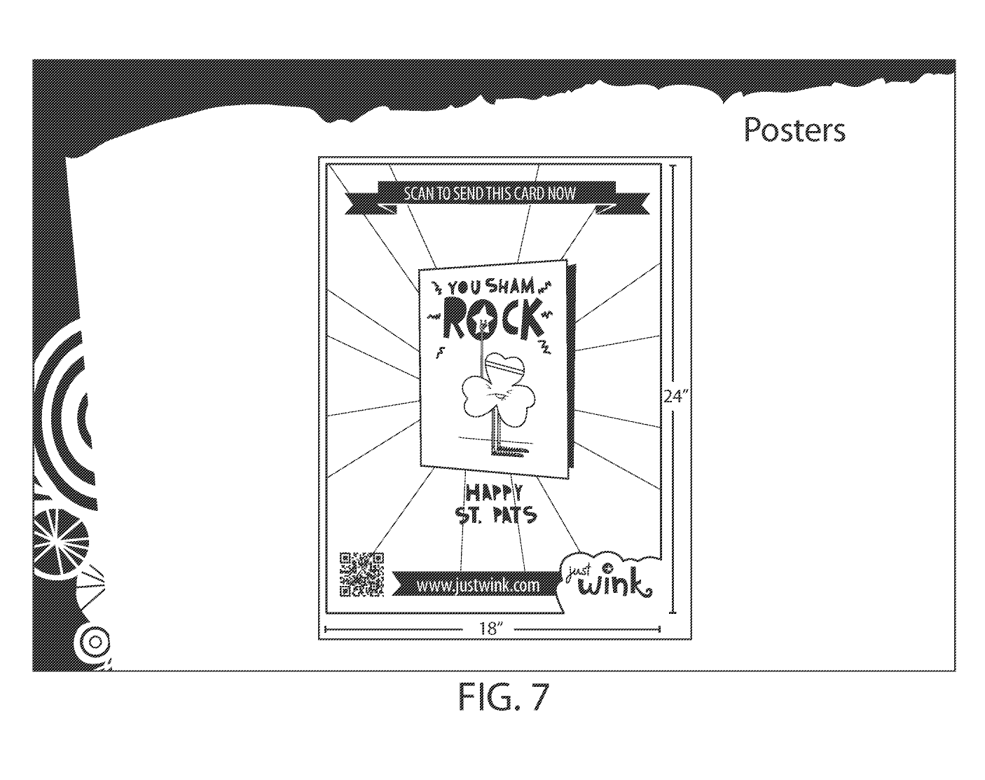

FIG. 2 shows exemplary marketing collateral in the form of stickers. 201, 202, and 203 are exemplary QR Codes and 204 is an exemplary vanity URL, either of which may be used by sender 150 to access and build the electronic greeting card 130 on the portable computing device 1001. FIG. 3 (Coffee Cup Sleeves), FIGS. 4-6 (Napkin Holders), FIGS. 7-9 (Posters) or paper greeting cards all represent other varieties of exemplary marketing collateral, which may be used to allow a sender 150 to access the QR Code 1002 or the URL 1005 described above. For example, the QR code may be printed on a physical paper greeting card as depicted in FIG. 2 of the '045 application, which is incorporated by reference in full in this application.

Although sender 150 typically first interacts with system 100 by scanning the QR Code 1002 on the marketing collateral, examples of which are provided above, sender 150 may directly access the mobile optimized browser builder 1302 by entering an appropriate URL 1005 for a particular electronic greeting card, or by entering a URL 1005 for a landing page, which then allows sender 150 to choose from one or more electronic greeting cards on their portable computing device 1001.

### USER OPERATION AND FLOW USING AN ECARD APP

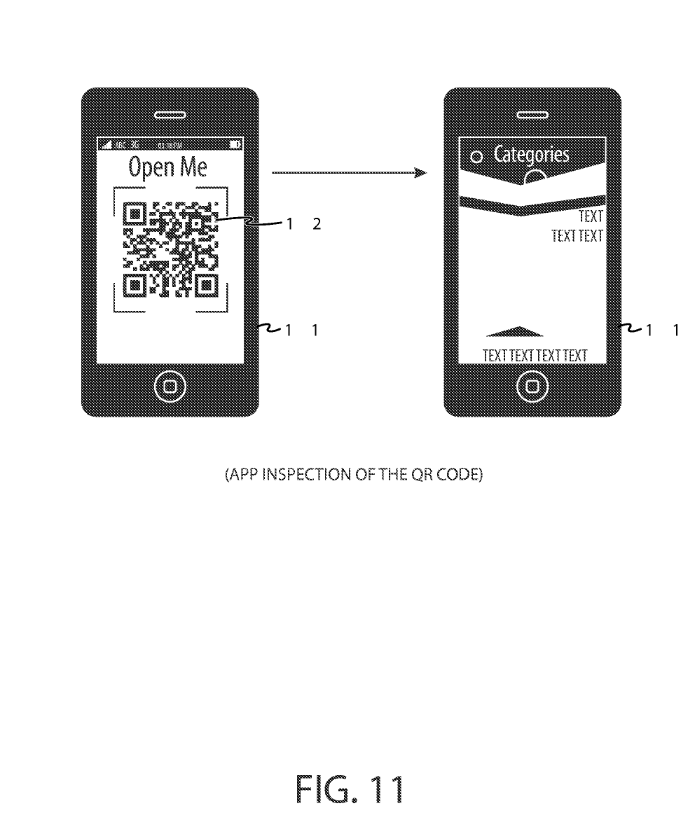

With reference to FIG. 10, sender 150 scans the QR Code 1002 resulting in the URL 1005 being resolved for by the portable computing device 1001 or enters the URL 1005 (hereinafter “the target URL 1005”) (not shown) using their portable computing device 1001. As shown in FIG. 11, the target URL 1005 performs an app detection check (“app inspection”) to verify whether or not the portable computing device 1001 has the ecard app 1201 installed. If the portable computing device 1001 has the ecard app 1201 installed, sender 150 will be directed to the ecard app 1201, as shown in FIG. 12. Here, sender 150 will be able to create, edit, distribute, and view electronic greeting cards on the portable computing device 1001. As described earlier with reference to FIG. 1, exemplary embodiments describing sender's interactions in downloading and installing the ecard app 1201, and the operations and flow of building and distributing an electronic greeting card via the ecard app 1201 are fully described in the '045 application.

### USER OPERATION AND FLOW OF MOBILE OPTIMIZED BROWSER BUILDER

In an embodiment, a mobile optimized browser builder 1302 used for creating, editing, distributing, and viewing electronic greeting cards on a portable computing device 1001 without requiring sender 150 or a receiver 160 (not shown) of the electronic greeting cards to download a mobile application or any other portable application for accomplishing said purposes is shown.

With reference to FIG. 13, a high-level representation of sender's operation with reference to the mobile optimized browser builder 1302 is shown. Sender 150 either scans the QR Code 1002 or enters the target URL 1005 (at 1301) using their portable computing device 1001. Information 1304 (not shown) regarding the scan or the URL is sent to a Reporting Server 1303. Information 1304 may be any pertinent information for the operation of the optimized browser builder 1302. Examples include the operating system of the portable computing device 1001, the browser information of the portable computing device 1001, any cached information on the portable computing device 1001 etc. Based on the information 1304, i.e., information specific to the portable computing device, the portable computing device 1001 opens the mobile optimized browser builder 1302.

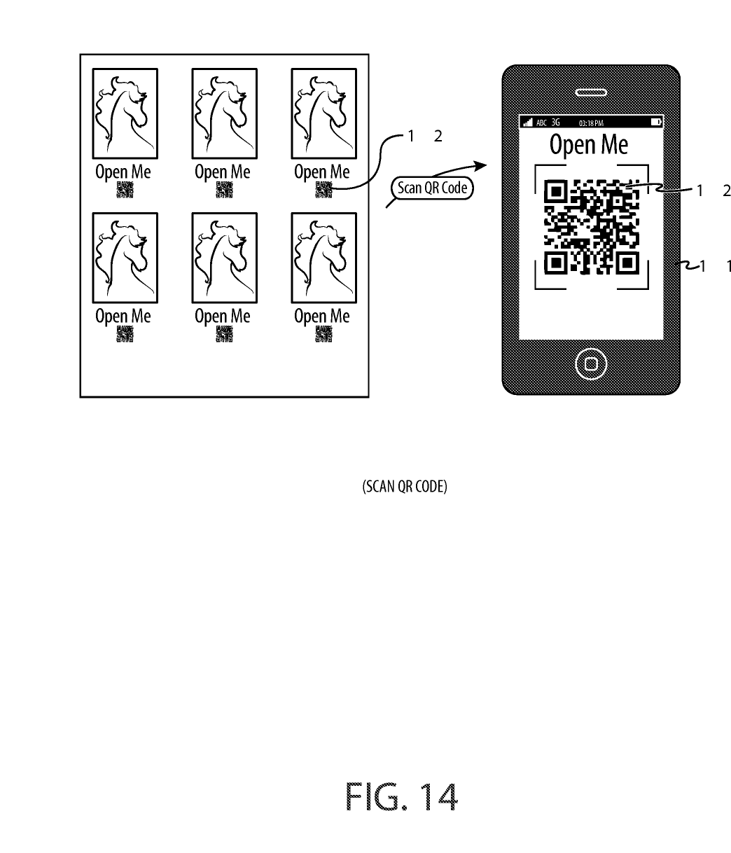

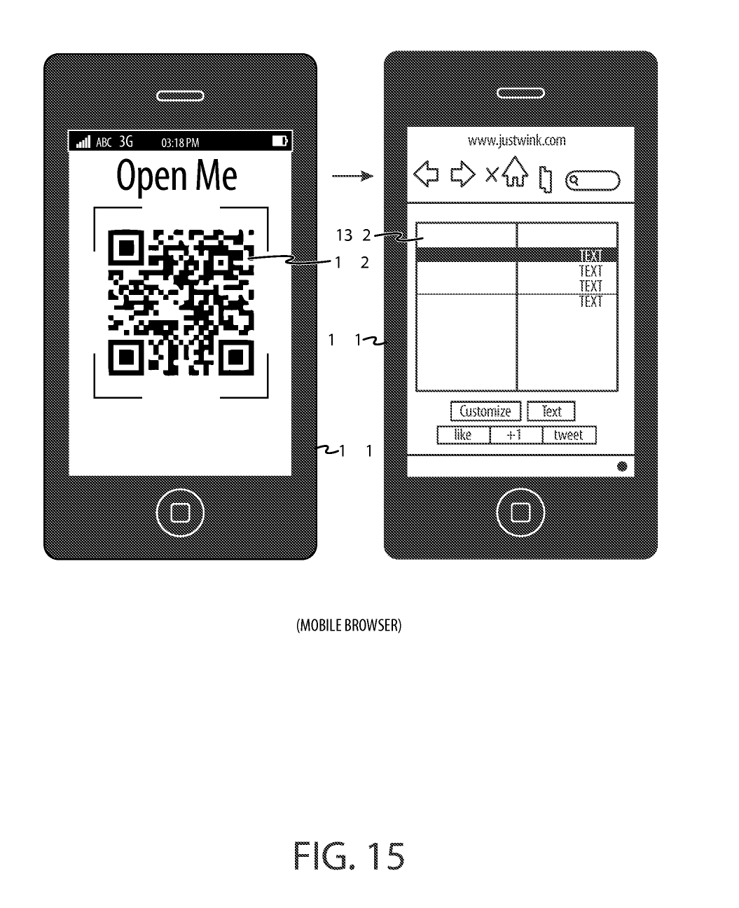

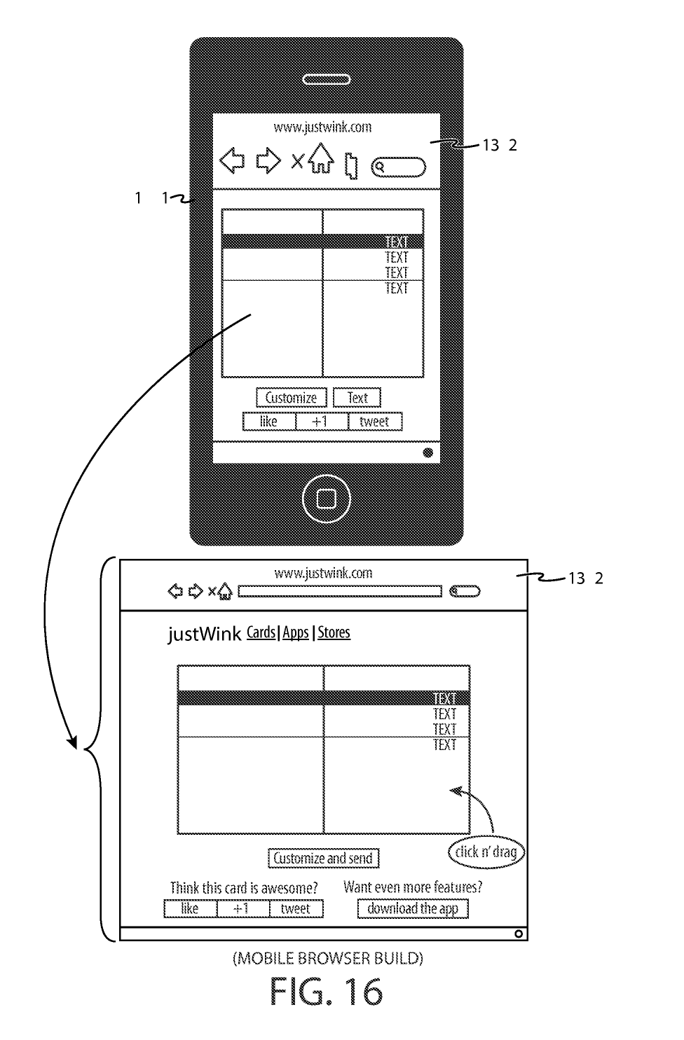

At FIG. 14, sender 150 scans the QR Code 1002 or enters the target URL 1005 using their portable computing device 1001. The QR Code 1002 or the target URL 1005 is used in conjunction with a “device detection” algorithm wherein the “type” of the portable computing device 1001 is detected using code written in the Python programming language. This embodiment may also involve detection of the header packet information or other identifying metadata of the portable computing device 1001. The type of the portable computing device is defined as the operating system of the device and/or the make and/or model of the device. Depending on the type of device 1001, a device-type specific version of the mobile optimized browser builder 1302 is rendered on the portable computing device 1001 (e.g. Android® or iOS® based device), as shown in FIG. 15. FIG. 16 shows an expanded view of the mobile optimized browser builder 1302. The mobile optimized browser builder 1302 is rendered to sender 150 on the portable computing device 1001 via JavaScript, an interpreted computer programming language.

During the rendering of the builder 1302, depending on the type of portable computing device 1001 used, an Application Programming Interface (an API) is utilized to provide the mobile optimized browser builder 1302 with a content catalog and specific electronic greeting card content 131 (not shown). The mobile optimized browser builder 1302 may also be configured to request electronic greeting card content 131 based on the device's screen size and resolution (i.e., pixel density). The API provides a nearest match for the requested sizes so that resources for a tablet computer, for example, will serve larger content than resources for smaller screened devices like a mobile phone.

In an embodiment, the API is utilized for the purposes of facilitating the rendering of Scalable Vector Graphics (Images) (SVG) on the portable computing device 1001, including external images which are stored in an SVG format. SVG format is a type of format which uses extensible markup language (XML) specifications to render static and dynamic two-dimensional vector graphics. The API is used for, but not limited to, visualization, scalable icons, scalable graphics, scalable text, scalable images, scalable dynamic text and other uses which require scalable data. The system interactions between the several SVG files, non-SVG files and the API is handled via a communication network 132 (not shown), comprised of the portable computing device 1001, the internet (not shown) and any host server(s) (not shown). Exemplary embodiments of the communication network 132 is shown in the '045 application. The communication network 132 uses the API as the bridge between the user's portable computing device 1001 and the SVG graphics and other files that comprise the electronic greeting card content 131. Source code (“app Source Code”) of the mobile optimized browser builder 1302 allows the user of the mobile optimized browser builder 1302 to interact with and manipulate the elements within an SVG file and any non-SVG files through the API.

In an embodiment, the user interacts with, or edits, or displays, or performs actions with, or views, or adds/edits/replaces information on a user interface of the mobile optimized browser builder 1302. The user interactions are enabled by system interactions between several SVG files, API files and the app Source Code. They include displaying, interacting with, and managing animations, loading text within SVG files, and loading dynamic text in the SVG files. Further, when the user wishes to interact with the screen of the smart phone, such user interactions are enabled by system interactions between several SVG files, API files and the app Source Code. These interactions are further described in the '045 application.

In an embodiment, the SVG files can be scaled. Unlike the files with Joint Photographic Experts Group (JPEG) properties and/or files with Graphics Interchange Format (GIF) properties, SVG files, and especially SVG images are scalable to the size of the window where the image is viewed. After rendering, the SVG file adjusts in size and resolution to the size of the viewing window. Additionally, the SVG files are interactive.

In an embodiment, the SVG files are formatted such that the resultant SVG file complies with XML specifications. The SVG files are created through text-based commands.

In an embodiment, the SVG files are utilized for many purposes, including but not limited to, transformations of objects, colors of a shape or text, opacity of a shape or text, gradients of a shape or text, textures of a shape or text, filling a shape or text, stroking a shape or text (stroke), clipping a shape or text, filter effects on a shape or text, inserting symbols or images at coordinates, interactive elements, event handling within and outside the script, scripting and animation functions.

In an embodiment, a document object may be used to access an SVG file or a non-SVG file. A document object may be used to inquire into the document properties of the SVG file or a non-SVG file as well as to create new document elements within the accessed document.

In an embodiment, several references within the accessed document can be retrieved using calls and pulls. In this context, calls may be viewed as requests for information and pulls may be viewed as the retrieval of said information requested.

Several API methods can be used to manipulate the SVG elements or non-SVG elements, each of which is associated with a definitive property or function. The API files can also be used to register event listeners to work with the SVG files or non-SVG files. An event listener listens for events such as a ‘return’ call (pressing the return key) within the portable computing device 1001.

In an embodiment, the SVG file (e.g., main.svg) is pulled from an exemplary cloud server 133 (not shown). The pulled SVG file creates an entry point into the SVG data associated with the pulled electronic greeting card 130. The pulled SVG file may reference to one or more additional SVG files or non-SVG files creating a resulting file. In an embodiment, the reference from the pulled SVG file to other SVG or non-SVG file(s) is achieved through a pull mechanism via an XINCLUDE or any other XML inclusion means.

In an embodiment, the resulting file, as described above, is parsed into a product model. The product model as used herein, includes, but not limited to, a symbol library containing references to images to be used in electronic greeting cards 130. The symbol library contains references to images for electronic greeting cards 130, which include, but are not limited to, sounds, files, static text, dynamic text, functions and images. The symbol library may also contain references to the usage of the images (assets) which include, but are not limited to, identifying whether the image is a background, a sticker, a portion of the electronic greeting card 130, a foreground, a font, a signature element, a text element, an image element, an audio element and an element which defines function of the image. The symbol library may also contain a list of “scenes.” The scenes may correspond to pages in a greeting card held in a physical (e.g. paper) medium. The list of scenes, includes, but not limited to, a front-cover scene, an inside left scene, an inside right scene, a back-cover scene and a middle page scene. The scenes may be comprised mostly of references to objects in the symbol library. For instance, a front cover scene may reference a background image from the symbol library. Also, a front cover scene may reference an audio clip from the symbol library which may be used for the purposes of background audio.

In an embodiment, the product code translates the SVG file(s), the non-SVG file(s), the resultant file and any references to the symbol library into a series of “draw” calls that the application performs, which directs the application into drawing or creating a page on the portable computing device's screen. In an embodiment, the application is directed into drawing or creating a page, without identifying the underlying SVG data.

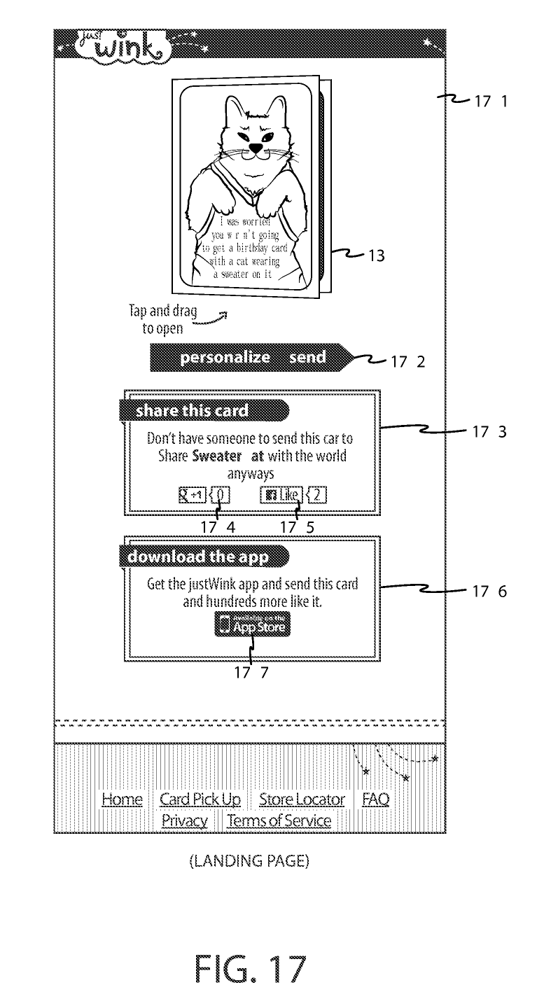

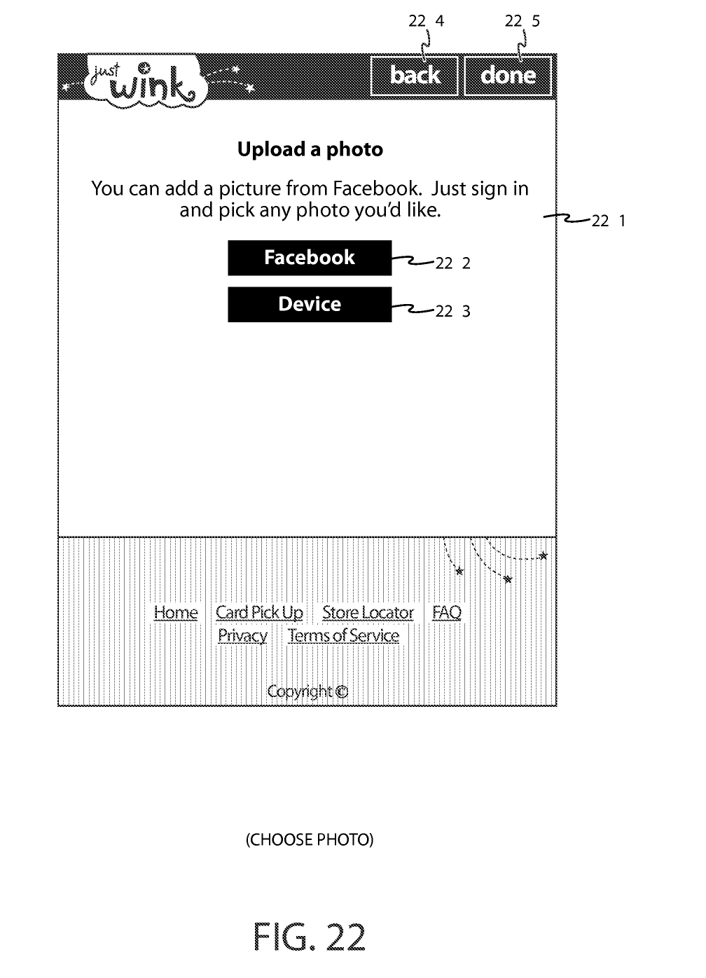

FIGS. 17-37 describe the operations of the mobile optimized browser builder 1302 for creating, editing, distributing, and viewing electronic greeting cards on a portable computing device.

FIG. 17 shows an exemplary embodiment of a “landing page” 1701 in the mobile optimized browser builder 1302. The landing page 1701 shows the specific exemplary electronic greeting card 130, a link 1702 to personalize and send the greeting card 130, a link 1703 to share and like the card 130 on Google+® (1704) and Facebook® (1705) respectively, a link 1706 to download the ecard app 1201 via the download store 1707.

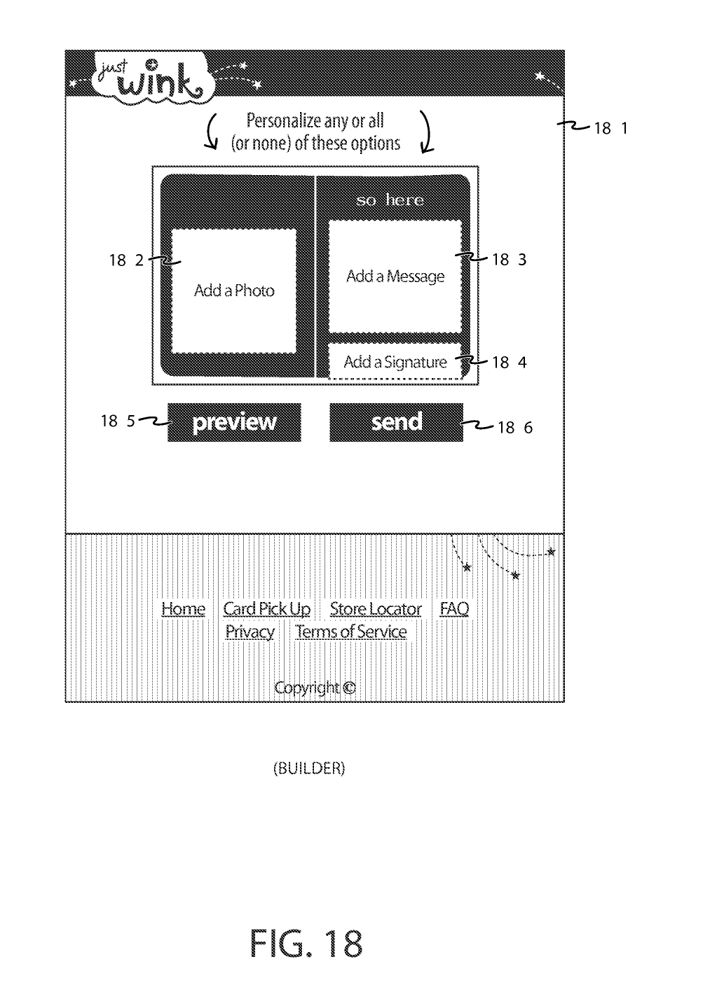

When sender 150 clicks on 1702 to personalize and send the card 130, the user is directed to the builder page 1801, as shown in FIG. 18. Builder page 1801 allows sender 150 to add a photo (1802), add a message (1803), or add a signature (1804). Sender 150 may simply send the card 130 by clicking on the send link 1806, or may preview the card 130 by clicking on the preview link 1805.

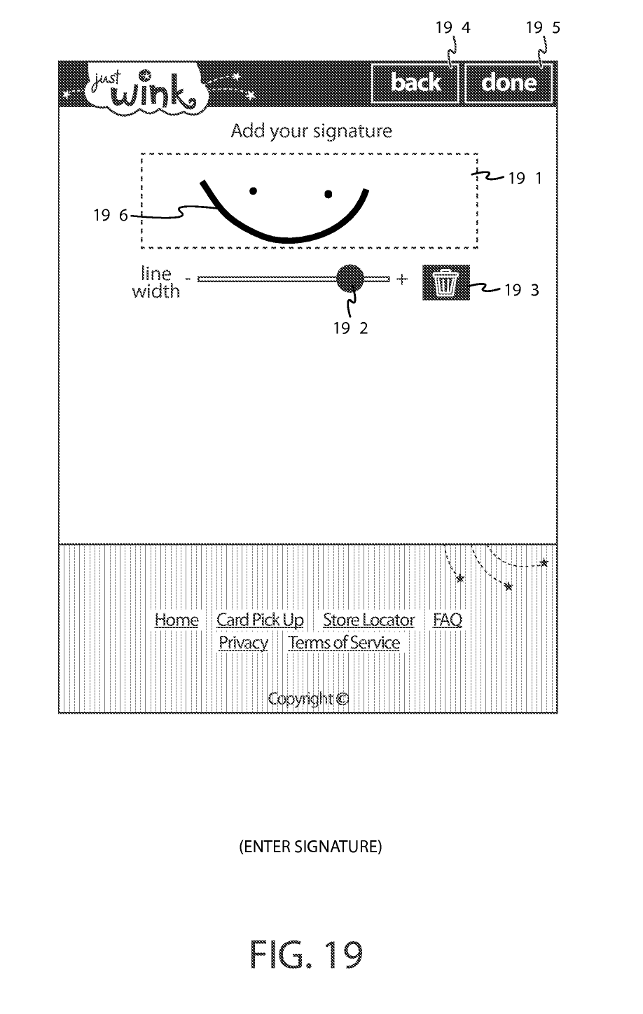

When sender 150 chooses to add a signature by selecting the link 1804, sender 150 is directed to the screen shown in FIG. 19, where sender 150 is able to add a signature 1906 in a signature area 1901. The size of the signature may be adjusted using the adjustment bar 1902. Adjustment bar 1902 may be a sliding bar as shown in FIG. 19, or may be any other type of selector, including radio buttons, size selection menus etc. Signature 1906 may also be deleted using the delete link 1903. Sender 150 may activate the back link 1904 to return to the builder page 1801 without saving the signature 1906. Sender 150 may also activate the done link 1905 to save the signature 1906 and return to the builder page 1801.

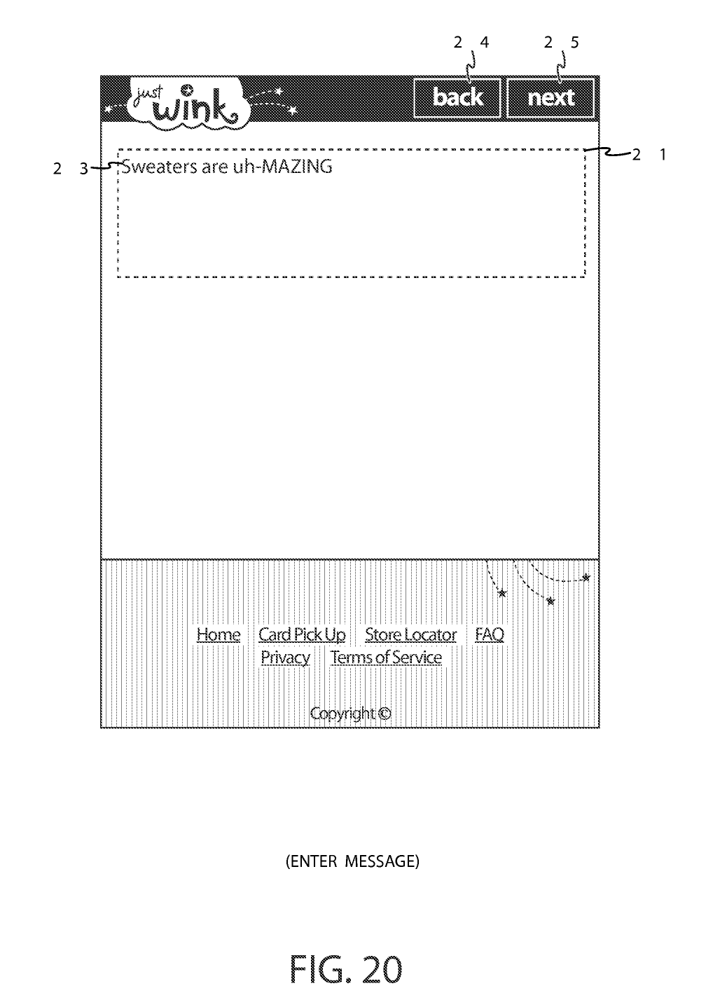

When sender 150 chooses to add a message by selecting the link 1804 in FIG. 18, sender 150 is directed to the screen shown in FIG. 20, where sender 150 is able to add a message 2003 in a message area 2001. Sender 150 may activate the back link 2004 to return to the builder page 1801 without saving the message 2003. Sender 150 may also activate the next link 2005 to save the message 2003 and move to the next screen 2101.

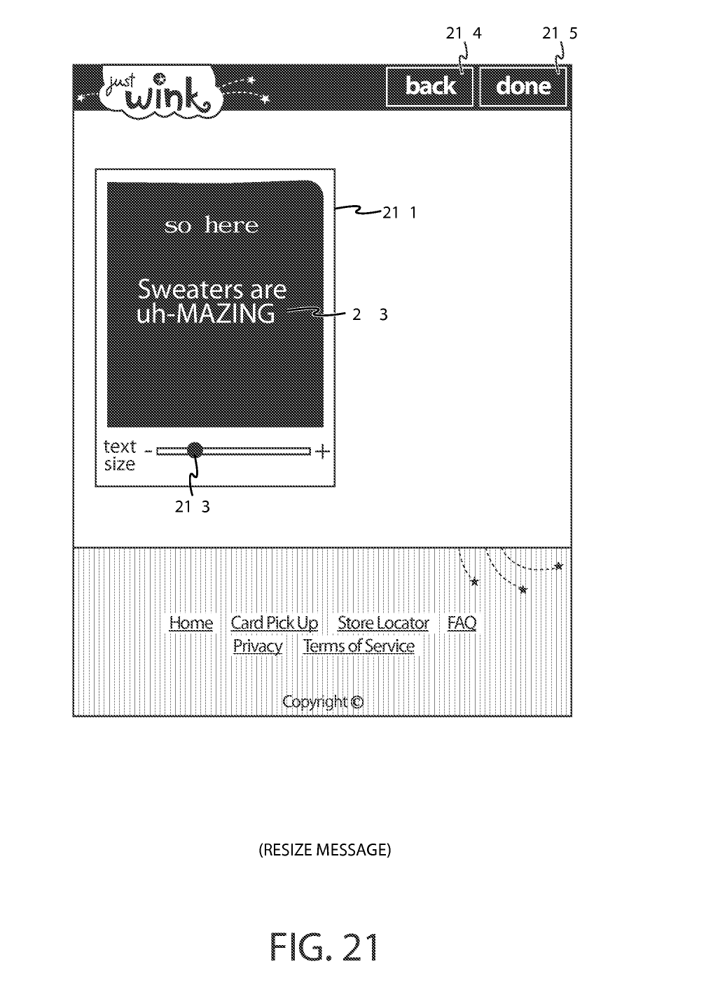

FIG. 21 shows the next screen 2101 where sender 150 is able to adjust the size of the message 2003 by using the adjustment bar 2103. Adjustment bar 2103 may be a sliding bar as shown in FIG. 21, or may be any other type of selector, including radio buttons, size selection menus etc. Sender 150 may activate the back link 2104 to return to the message screen 2001 without saving the message 2003. Sender 150 may also activate the done link 2105 to save the message 2003 and return to the builder page 1801. The use of the “back” and “done” links are likewise consistently applied in the rest of the mobile optimized browser builder 1302.

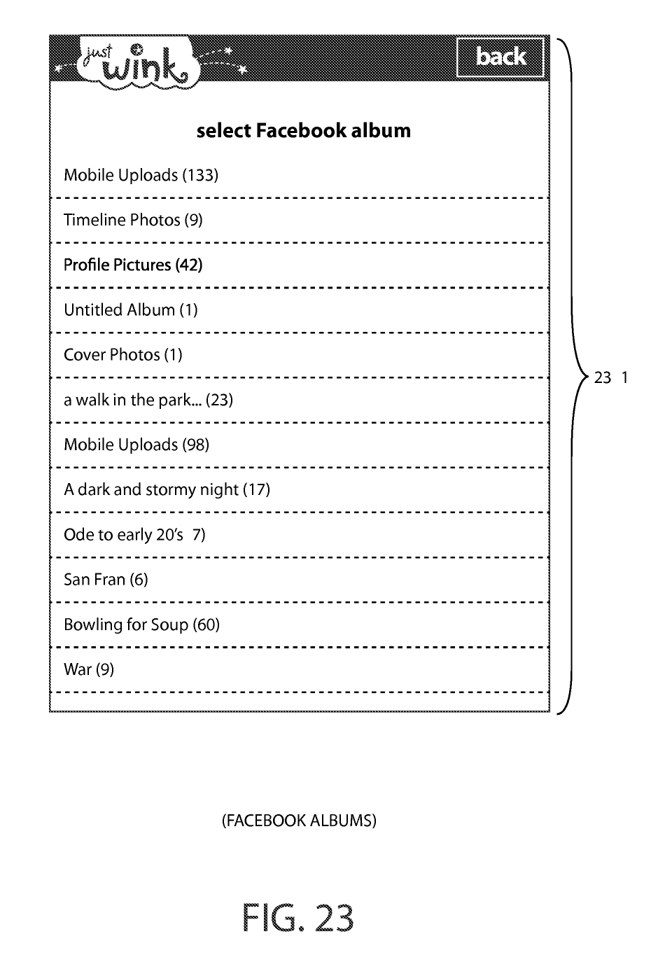

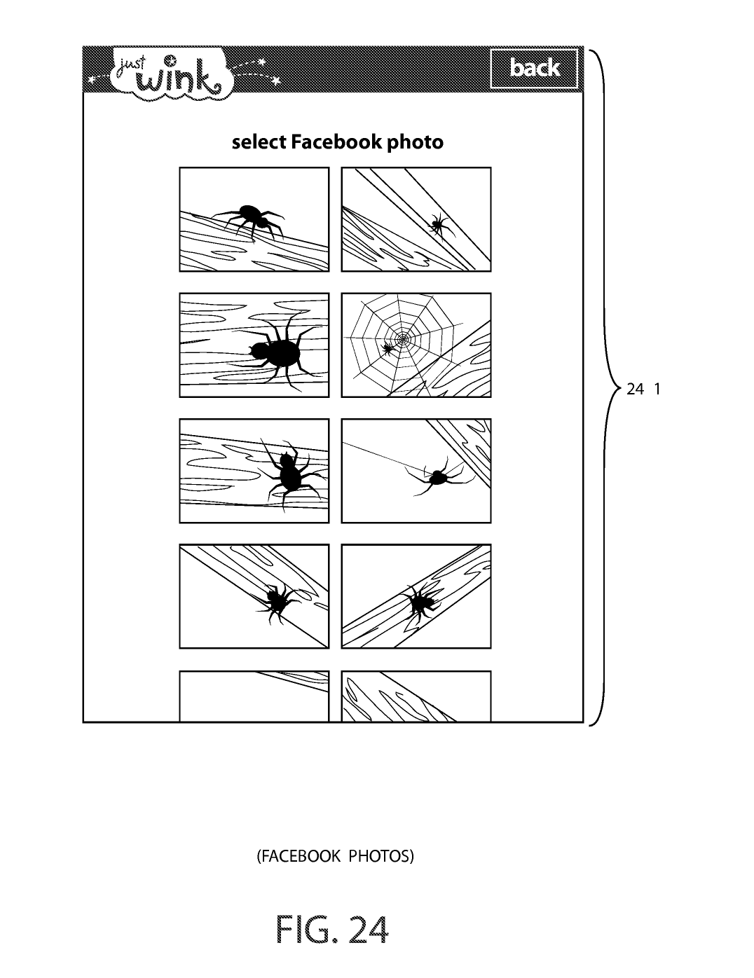

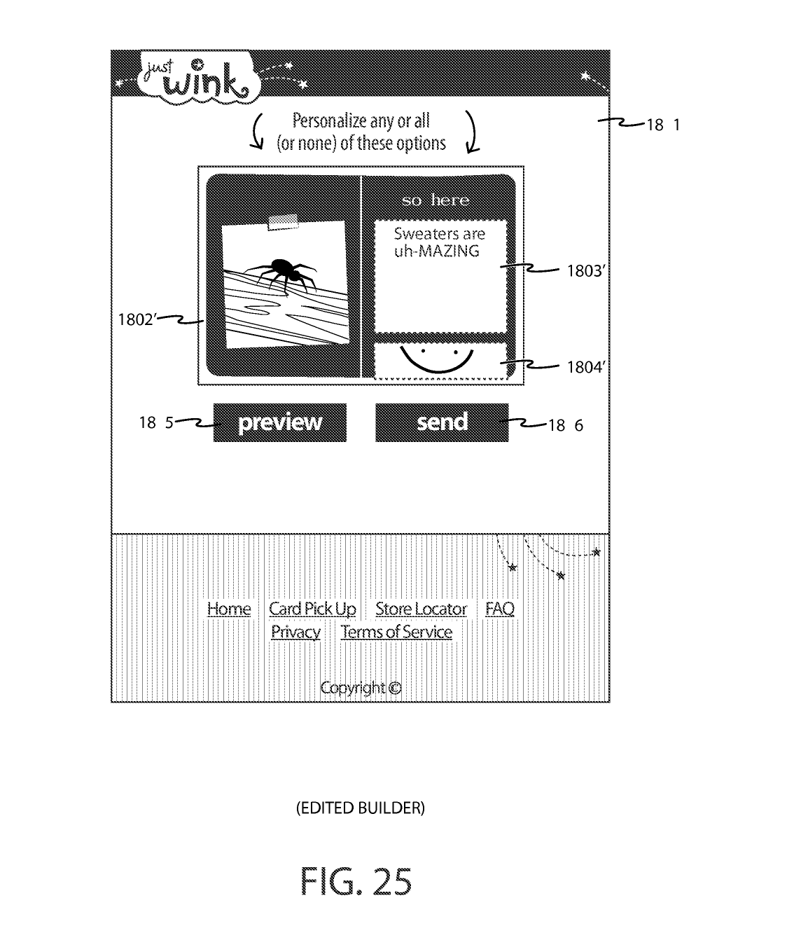

When sender 150 chooses to add a photo by selecting the link 1802 in FIG. 18, sender 150 is directed to an upload photo screen shown in 2201, where sender 150 is able to choose from uploading a photo from Facebook® 2202, or uploading a photo from the portable computing device 1001, at 2203. If sender 150 chooses the option to upload the photo via Facebook® 2202, and sender 150 is not already signed in to the Facebook® service on the portable computing device 1001, sender 150 is directed to a login screen where sender 150 is able to enter their user credentials (e.g. a username and a password). Sender 150 is then presented with their Facebook® albums 2301 in FIG. 23. Choosing an album redirects sender 150 to the individual photos 2401 in FIG. 24. Sender 150 may choose a photo from the photos 2401. Then, sender 150 is directed to builder 1801 in FIG. 25, which now shows the selected photo incorporated at 18021. The screen in FIG. 25 shows an embodiment of builder 1801 with the various customizations adopted by sender 150, represented by 18021 (photo), 18031 (message), and 18041 (signature).

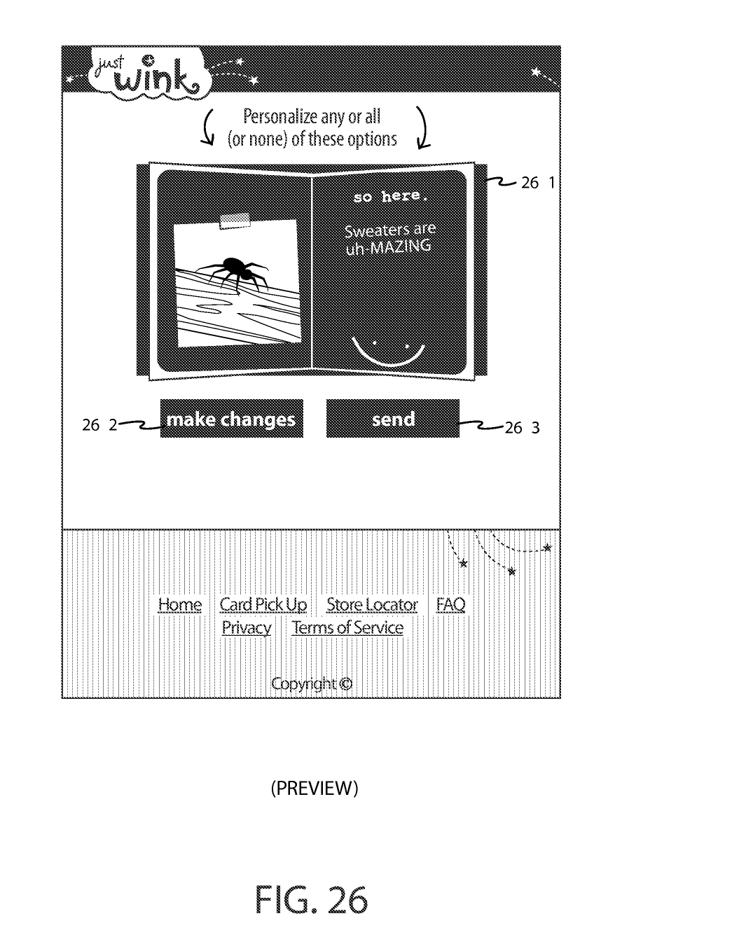

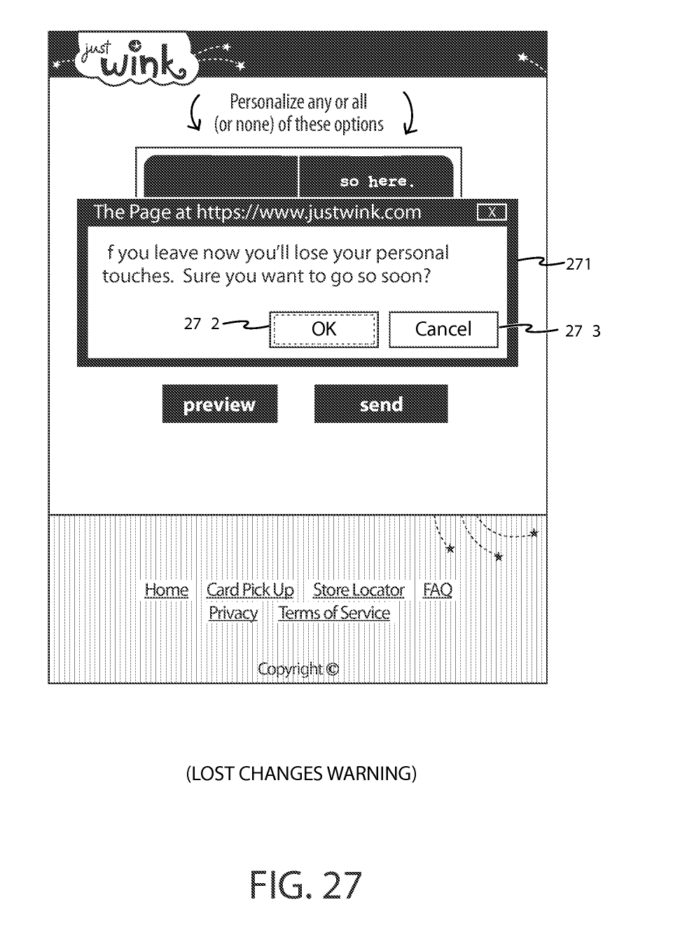

If sender 150 selects the preview link 1805, sender 150 is directed to a preview screen 2601 as shown in FIG. 26. The preview screen 2601 shows the customized or original views of the photo, message, and the signature as it pertains to the card 130. If sender 150 chooses to make further changes, sender 150 may select the make changes 2602 link, whereby sender 150 is directed to the Lost Changes Warning screen 2710 shown in FIG. 27. If sender 150 chooses to cancel by selecting link 2703, sender 150 is directed back to the preview screen 2601. If sender 150 confirms the change by selecting the OK link 2702, sender 150 is taken back to builder 1801 to re-initiate the process of customization of the card 130.

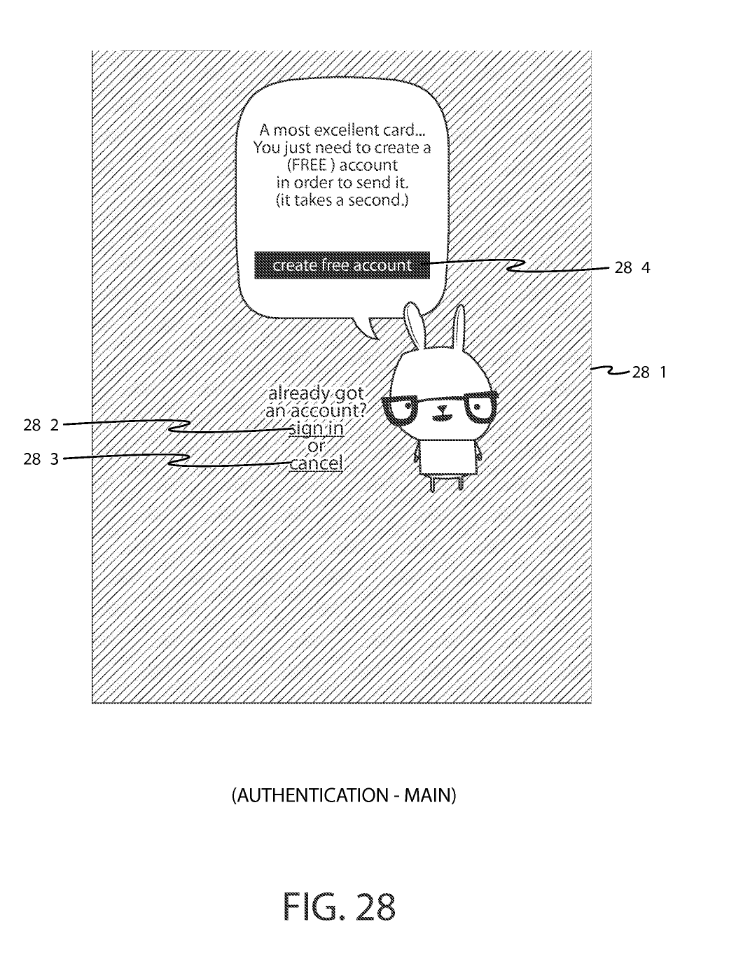

If sender 150 chooses to send the card by activating the send links 1806 (FIG. 18) or 2603 (FIG. 26), sender 150 is directed to an authentication screen 2801 as shown in FIG. 28, where the user is given the choice to either signing in by selecting the link 2802, canceling by selecting the link 2803, or creating a new account by selecting the link 2804.

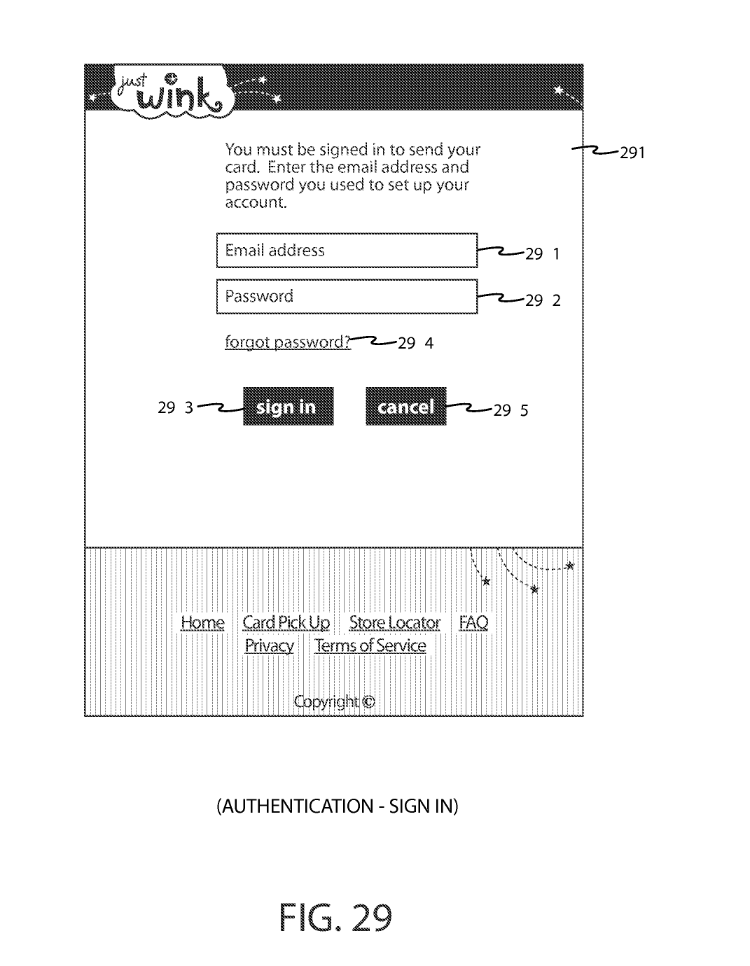

If sender 150 chooses to sign in by selecting the link 2802, sender 150 is directed to a sign-in page 2910 as shown in FIG. 29. Here, sender 150 may enter a username 2901 and password 2902, and sign in by selecting the link 2903. Sender 150 has an option to cancel the transaction by selecting the link 2905 or to request a new password by selecting the forgot password link 2904.

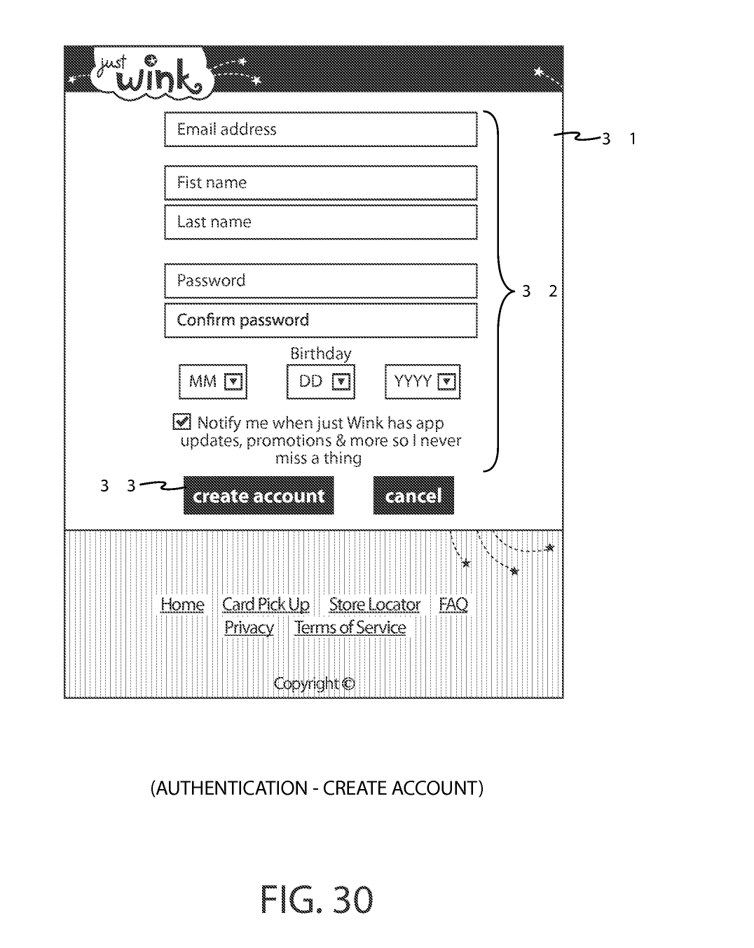

If sender 150 chooses to create a new account 2804 as shown in FIG. 28, sender 150 is directed to a new account page 3001 as shown in FIG. 30. Sender 150 may enter one or more sign up details 3002 (e.g. email address, first name, last name, password, date of birth) to create a new account with the system 100. Sender 150 may then select the create account link 3003 to create a new account.

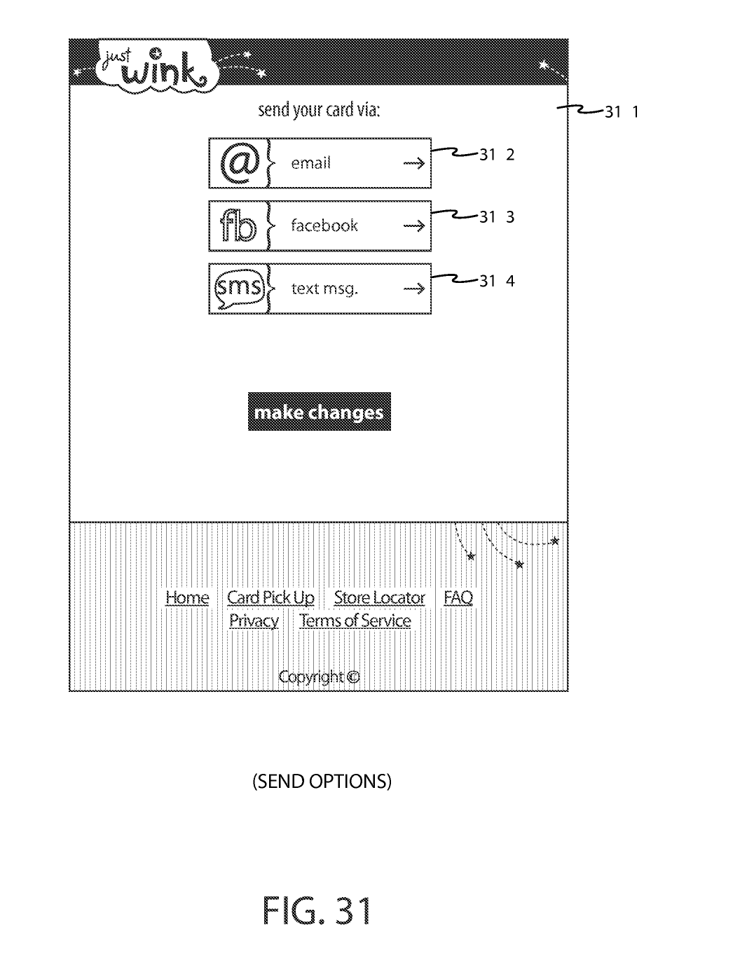

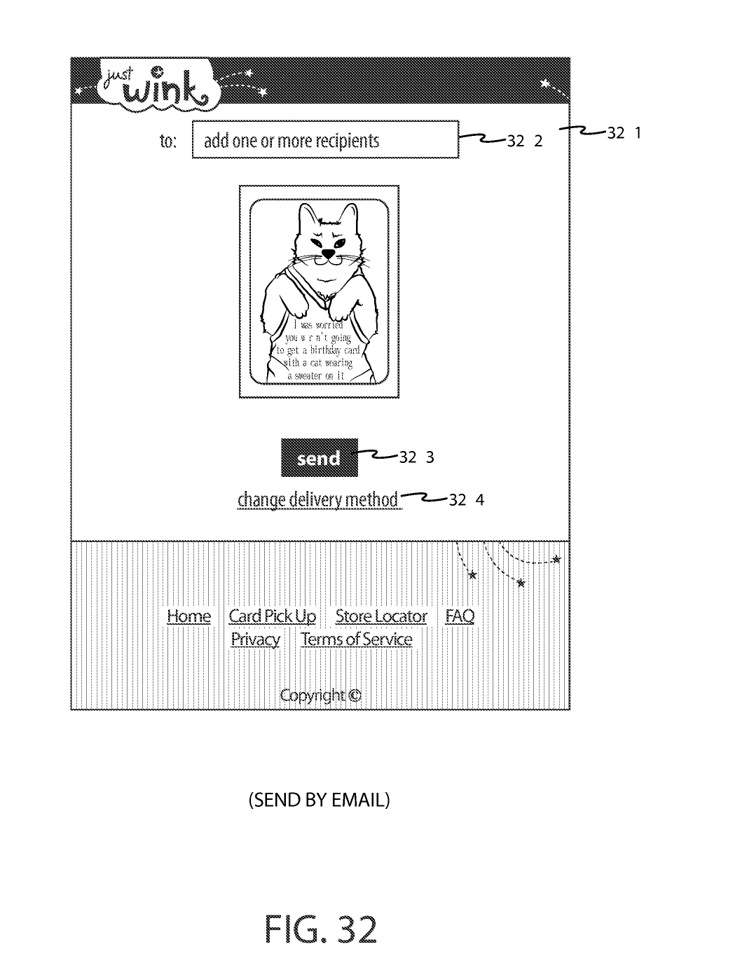

Once sender 150 either creates a new account or signs in, sender 150 is directed to a send options screen 3101 as shown in FIG. 31. The send options screen 3101 allows the user to send the card 130 via email (3102), Facebook® (3103), or text message (3104). If sender 150 chooses to send the card 130 via email (3102), sender 150 is directed to an email page 3201 as shown in FIG. 32. The email page 3201 has an option for sender 150 to enter one or more email addresses in the email box 3202 and send the card 130 by selecting the send link 3203. Sender 150 may also change the delivery method by selecting the link 3204, which takes sender 150 back to the send options screen 3101 as shown in FIG. 31.

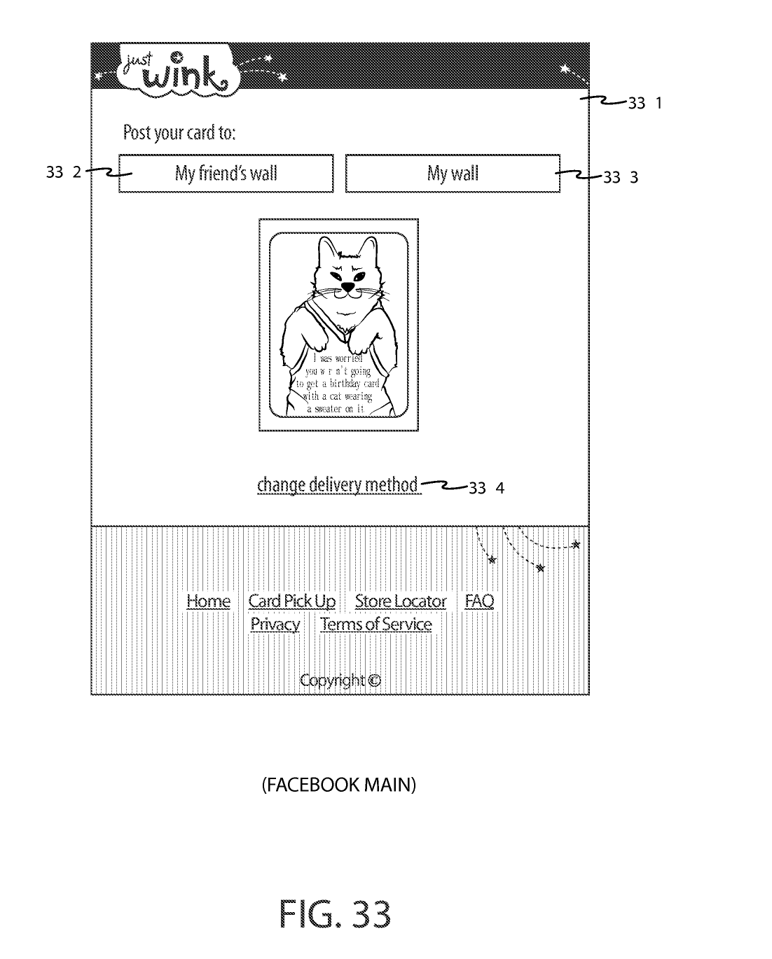

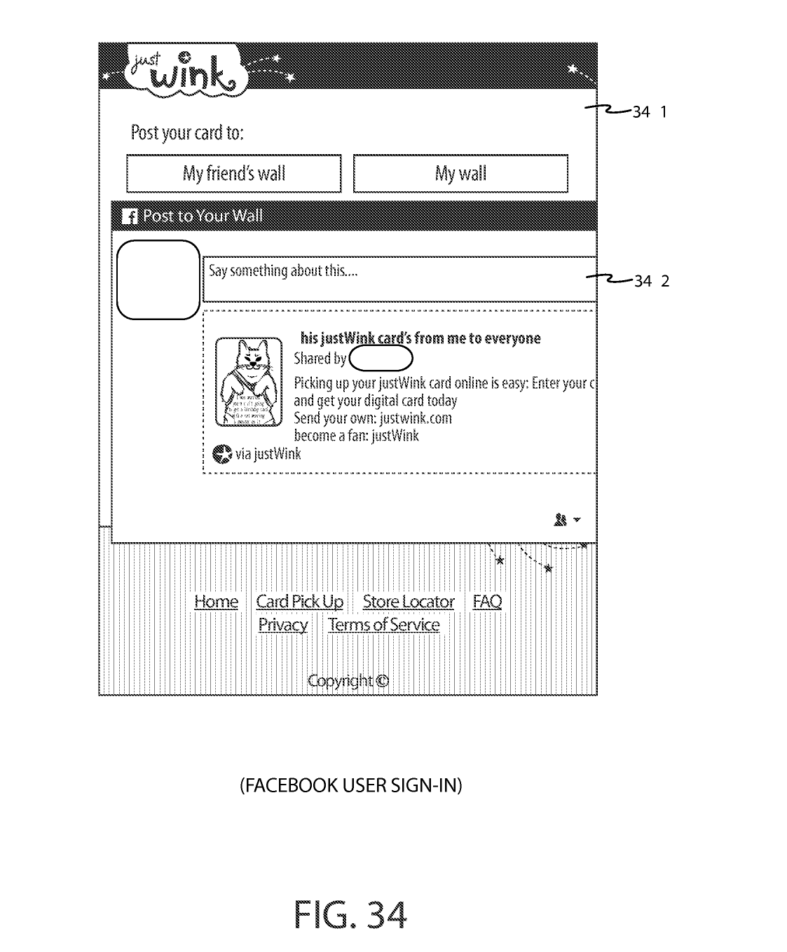

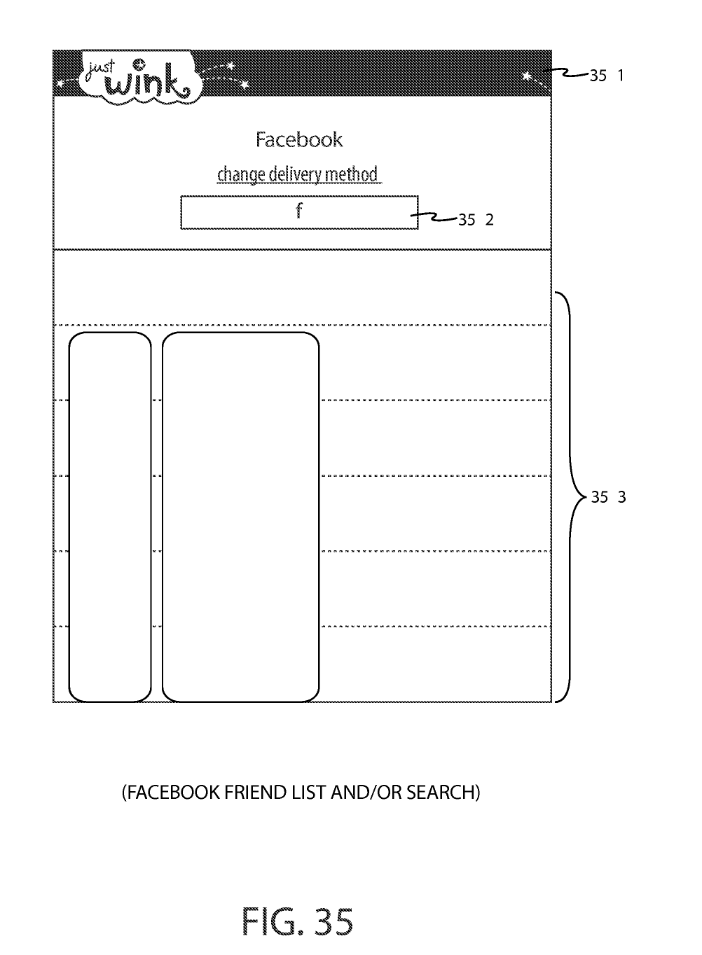

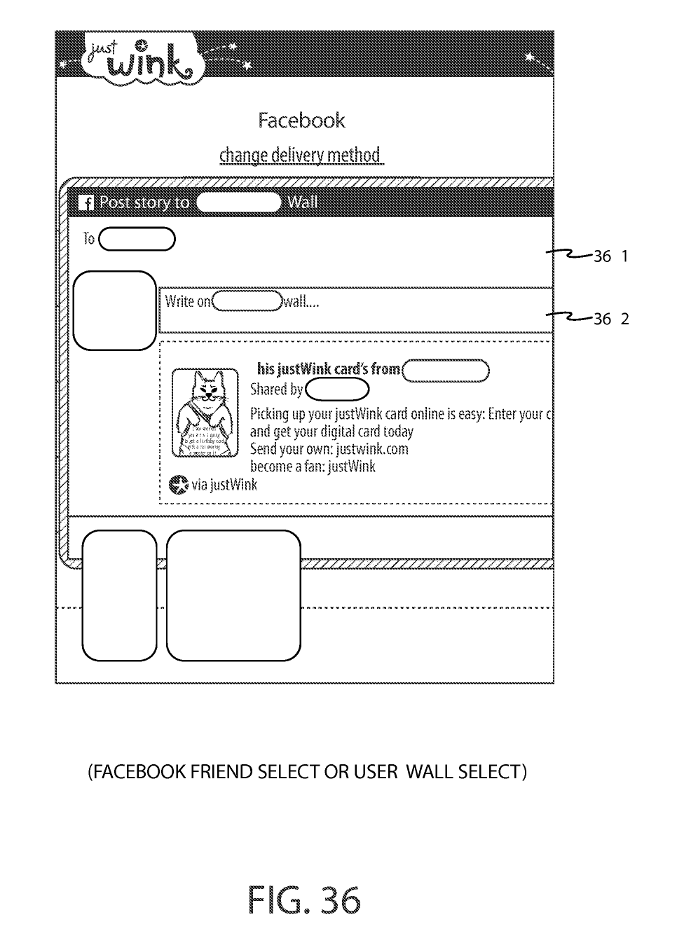

If sender 150 chooses to send the card 130 using Facebook® by selecting the link 3103 in FIG. 31, sender 150 is directed to a Facebook® page 3301 as shown in FIG. 33. Here, sender 150 is able to choose between posting the card 130 on their own Facebook® wall 3303 or on a friend's Facebook® wall 3302. Sender 150 may also change the delivery method by selecting the link 3204, which takes sender 150 back to the send options screen 3101 as shown in FIG. 31. If sender 150 chooses to post the card 130 on their own Facebook® wall 3303, sender 150 is directed to a Facebook® wall page 3401 as shown in FIG. 34, where sender 150 is able to post the card 130 along with a personalized message 3402 on their Facebook® wall. If sender 150 chooses to post the card 130 on their friend's Facebook® wall 3302, sender 150 is directed to a Facebook® friend page 3501 as shown in FIG. 35, where sender 150 is able to choose from one or more friends 3503 by either selecting them from the list or by searching for them in 3502. Once sender 150 chooses to post the card 130 to a selected friend's wall, sender 150 is directed to a Facebook® wall page 3601 (for the selected friend) as shown in FIG. 36, where sender 150 is able to post the card 130 along with a personalized message 3602 on to the friend's Facebook® wall 3601.

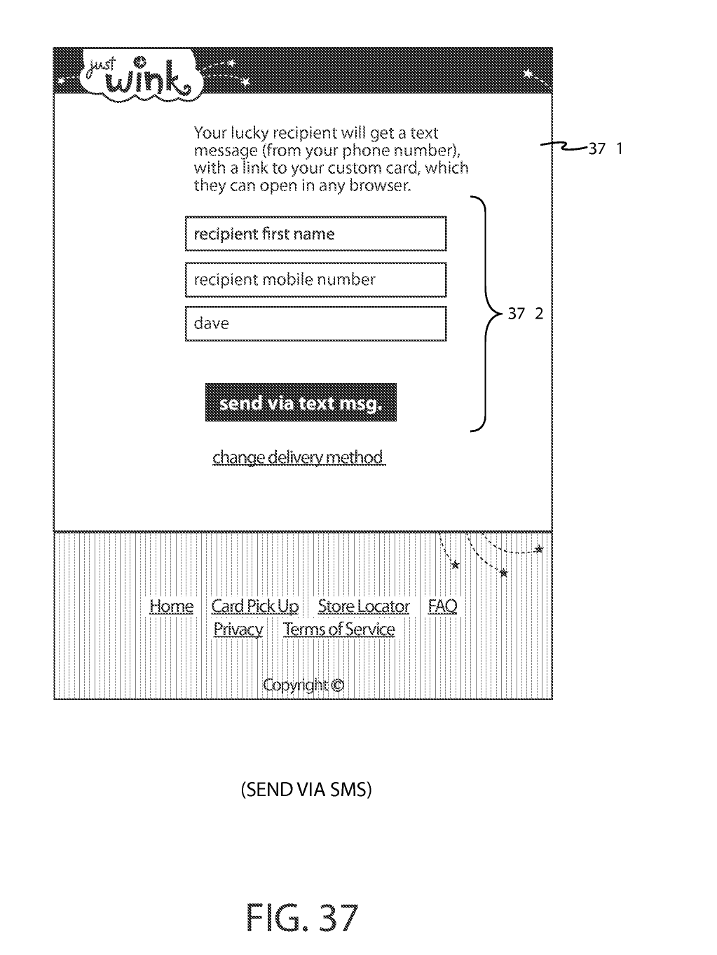

If sender 150 chooses to send the card 130 using the text message link 3104 as shown in FIG. 31, the sender 150 is directed to a text message page 3701 as shown in FIG. 37. Sender 150 is able to fill out receiver's (160) contact information 3702 (e.g. first name, mobile number, personalized message). The contact information 3702 may also be extracted from the portable computing device 1001. The text message may also be sent using native text message sending options built into the portable computing device 1001.

The receiver's (160) interactions in receiving and viewing the card 130 through the mobile optimized browser builder 1302 is similar to receiving the card 130 through the ecard app 1201, except that in the latter, the receiving and the viewing require the ecard app 1201 to be downloaded and installed. In such parts where receiving and the viewing of the card 130 require the ecard app 1201 to be downloaded and installed, such operations may be accomplished on the mobile optimized browser builder 1302 directly. The operations and flow of receiving and viewing the electronic greeting card 130 via the ecard app 1201 are fully described in the '045 application.

As described earlier, the mobile optimized browser builder 1302 is rendered to sender 150 on the portable computing device 1001 via JavaScript, an interpreted computer programming language. The mobile optimized browser builder 1302 is essentially a single web page JavaScript application. All of the page interactions (e.g. 1801) happen through JavaScript, in addition to CSS and Canvas (a class in Java® programming). The rendering of the card 130 happens through SVG and XML via the API described above. JavaScript also drives the editing of the card 130; selecting and uploading photos from Facebook®, device storage or device camera; previewing the edited card 130; authenticating sender 150 and receiver 160s (including sign-ins and new account creations where JavaScript XHR is initiated to a Python backend); choosing a send method; connecting and sharing on Facebook® (by utilizing the Facebook® JavaScript SDK); and sending the card 130 (JavaScript XHR is initiated to API). JavaScript XHR and API are also utilized in uploading ground images to a backend database in system 100. Further, advanced image processing and rendering on the internal pages of the card 130 are accomplished using JavaScript and Canvas.

All the same functionality and the software flow that can be accomplished by the ecard app as described in the '045 application can also be accomplished and implemented via the mobile optimized browser builder 1302.

The above description of specific embodiments has been given by way of example. From the disclosure given, those skilled in the art will not only understand the general inventive concepts and attendant advantages, but will also find apparent various changes and modifications to the structures and methods disclosed. For example, although the embodiments disclosed herein have been primarily directed to a portable computing device, the general inventive concepts could be readily extended to a personal computer (PC) or other relatively fixed console computers, and may be pursued with reference to a website and/or other online or offline mechanisms. Further, other social networking sites other than those specifically described herein may be used as delivery media for electronic greeting cards. As another example, the general inventive concepts are not typically limited to any particular interface between a user and the user's mobile computing device. Thus, for example, use of alternative user input mechanisms, such as voice commands and keyboard entries, are within the spirit and scope of the general inventive concepts. As a further example, the general inventive concepts are not typically limited to just mobile web browsers. Other browsing environments which permit the rendering and usage of the mobile optimized browser builder may be employed. For example, social networking applications such as Facebook® and Twitter® may be utilized to render and use the mobile optimized browser builder pages (e.g. within the Facebook® browser). It is sought, therefore, to cover all such changes and modifications as fall within the spirit and scope of the general inventive concepts, as described and claimed herein, and equivalents thereof.

We claim:

1. An electronic greeting card system comprising:
a server;
a code printed on a marketing collateral item;
an electronic greeting card application program that is rendered to a portable computing device from the server in response to the portable computing device scanning the code on the marketing collateral item;
a builder for modifying the electronic greeting card and rendered to the portable computing device; and
a means for selecting a medium to be used to send the greeting card from a group of sending media provided by the builder.

2. The system of claim 1 wherein the medium to be used to send the greeting card is email.

3. The system of claim 1 wherein the medium to be used to send the greeting card is a social network.

4. The system of claim 1 wherein the medium to be used to send the greeting card is text message.

5. The system of claim 1 wherein the code is a Quick Response code.

6. The system of claim 1 wherein the greeting card is rendered using scalable vector graphics.

7. The system of claim 1 wherein the electronic greeting card is rendered through an API that corresponds to the portable computing device.

8. The system of claim 1 wherein the at least one greeting card comprises four pages, with at least one of the four pages having an option to customize, and each of the four pages being movable by a touch of a finger.

9. The system of claim 8 wherein at least one of the four pages is customized by adding an electronic signature.

10. The electronic greeting card application of claim 8 wherein at least one of the four pages of the greeting card is customized by adding a personalized message.

11. The electronic greeting card application of claim 8 wherein at least one of the four pages of the greeting card is customized by adding a digital photograph.

12. A method for rendering a specific electronic greeting card to portable computing devices comprising:
a. providing an item of marketing collateral having a QR code;
b. rendering a builder to one of the portable computing devices based on a type of the one of the portable computing devices in response to scanning the QR code; and
c. rendering a complete specific electronic card to the one of the portable computing devices after the electronic card has been modified using the builder.

13. The method of claim 12 wherein the method includes determining the type of the one of the portable computing devices.

14. The method of claim 12 wherein the method includes the step of sending the electronic greeting card by email.

15. The method of claim 12 wherein the method includes the step of sending the electronic card using a social network.

16. A system for building a specific electronic greeting card comprising:
a. a web server;
b. a marketing collateral item having a code;
c. a builder rendered by the web server to a portable computing device for modifying the specific electronic greeting card in response to scanning the code; and
d. a completed specific electronic greeting card rendered by the web server in response to commands provided to the builder.

17. The system of claim 16 wherein the web server renders the complete greeting card based on a particular type of the portable computing device.

18. The system of claim 17 wherein the completed specific greeting card is rendered through the builder using SVG files.

19. The system of claim 17 wherein the completed specific greeting card is rendered through the builder using an API.

20. The system of claim 16 further including a means for signing the completed specific electronic greeting card.
